(19) United States
(12) Patent Application Publication
(10) Pub. No.: US 2004/0158350 A1
(43) Pub. Date: Aug. 12, 2004

(54) Medicine dispenser

(76) Inventors: Jens Ostergaard, Lejre (DK); Jesper Barfoed, Dronningmolle (DK); Ole Ingemann Olsen, Charlottenlund (DK); Ole Geisler, Copenhagen (DK)

Correspondence Address: HARNESS, DICKEY & PIERCE, P.L.C., P.O. BOX 8910, RESTON, VA, 20195, US

(21) Appl. No.: 10/477,019

(22) PCT Filed: May 15, 2002
(86) PCT No.: PCT/DK02/00318

(30) Foreign Application Priority Data
May 15, 2001 (DK) PA 2001 00766

(51) Int. Cl. G06F 17/00

(52) U.S. Cl. 700/231

(57) ABSTRACT

The present invention relates to the art of dispensing medicine to a user of medicine, and relates in particular to a medicine dispenser for dispensing doses of medicaments, a loader for loading doses of medicine into the medicine dispenser, a medicine distribution box, a packing device for packing medicaments in predefined doses, a Central Medication Database and a system comprising all these objects. Furthermore, the invention relates to a method of dispensing doses of medicaments, a method of loading medicine into a medicine dispenser, a method of distributing medicine, a method of packing medicaments in predefined doses, a method of carrying out various aspects related to dispensing medicine as well as a method integrating all the above mentioned methods.

The present invention relates to the art of dispensing medicine to a user of medicine, and relates in particular to a medicine dispenser for dispensing doses of medicaments, a loader for loading doses of medicine into the medicine dispenser, a medicine distribution box, a packing device for packing medicaments in predefined doses, a Central Medication Database and a system comprising all these objects. Furthermore, the invention relates to a method of dispensing doses of medicaments, a method of loading medicine into a medicine dispenser, a method of distributing medicine, a method of packing medicaments in predefined doses, a method of carry out various aspects related to dispensing medicine as well as a method integrating all the above mentioned methods.

In general, correct timing of intake of correct doses of medicine may be essential for correct compliance, where as intake of medicine at adverse times or time distances may reduce the effect of the medicine and in worst cases be harmful or even lethal.

It is an object of preferred embodiments of present invention to provide aids to remind the medicine the user of taking his medicine, which aids preferably is/are provided as an apparatus that dispenses medicine either on demand or automatically at given times. In particular, it is an object of preferred embodiments of the present invention to allow presentation of medicine doses at right time, e.g. pre-defined time, to a medicine user as well as to prevent presentation of medicine doses to the medicine user when the time is not right.

In many cases, medicine is distributed in blister packet and in case of cross contamination, where one type of medicine will react in a detrimental way with another type of medicine the medicine cannot be distributed in a common blister packet, and hence the medicine user would need a multitude of blister packets (or pill containers) in this case.

It is a further object of preferred embodiments of the present invention to provide a packing, preferably to be used in connection a pill dispenser according to the present invention, in which the risk of cross contamination is avoided or at least minimised.

A facility, a dispenser, to remind the user to take their medicine is known from WO 01/08106. This known facility includes electronic writing- and reading means adapted to read information and write information for an electronic memory carried by a medicine package in order to gather information concerning medication and to write information about used medication into the memory. Further dispensers are known from U.S. Pat. No. 5,392,952; U.S. Pat. No. 6,332,100, PCT application No. WO 97/08078 and from German Patent Application DE 199 38 298.

In known dispensers, where access to the medicine is either under complete control of the user, or where the dispensed medicine is actually physically presented by the dispenser, proper use or disposal of unused medicine rely entirely on the user control. Hence medicine, that is dispensed may or may not be used correctly and may or may not be reused at proper time or disposed of correctly.

Thus, the present invention relates in a first aspect to a dispensing unit for dispensing doses of one or more medicaments housed in the dispensing unit, the dispensing unit comprising

an electronic control unit controlling electrical activated mechanical manoeuvre means being adapted to manoeuvring a dose housed in the dispensing unit from a location where the dose can not be presented to a user and to a location where the dose can be presented to a user,

memory means for storing information on medication of doses housed in the dispensing unit,

a clock, and

means for receiving and storing information about a particular dose's preferred time of dispensing.

Preferably, the means for receiving and storing information is adapted to receive and store while one or more doses are being introduced into the dispensing unit. Furthermore, the manoeuvre means is preferably adapted to manoeuvre a dose to a location within the dispensing unit where it can not be presented to a user subsequent to having manoeuvred said dose to a location where it can be presented to a user, the time window in which the dose can be presented is preferably contained in the information received and stored. Information may advantageously also be received via the Internet by connecting the dispenser to the Internet. The manoeuvring is preferably ruled out by a time schedule contained in the or identified by information received and stored.

In preferred embodiments of the dispensing unit according to the present invention, the unit may preferably further comprise an identification tag uniquely identifying the dispensing unit and/or the user of the dispensing unit, whereby un-authorised access to medicine in the unit may be avoided.

Preferably, the means for receiving and storing information is adapted to sense the information from dose or dose distribution box to be introduced into the dispensing unit; said information be preferably applied on the dose or the distribution box in the form of bar codes, magnetic coding or the like preferably in readable and writeable form.

Further, the means for receiving and storing information is preferably adapted to receive the information via a wireless network, the receiving being preferably based on a unique identification of the dispensing unit and/or the user of the dispensing unit and preferably based on a preferably unique identification of the doses being introduced into the dispensing unit, said identification of the doses being preferably contained in information applied on the dose or the doze magazine.

In order to ease opening of dose packet dispensed by the unit, the unit preferably comprises one or more cutting devices adapted to cut open a dose presented by the dispensing unit, said cutting devices being preferably shielded and/or shaped so as to avoid cutting skin and cloth.

Preferably, the dispensing unit is adapted to detecting dispensing (removal of the dose being presented from the dispenser) of a dose in order to keep track of the doses dispensed by the dispenser. This feature may advantageously be combined with adapting the dispenser to store the time a dose is presented.

In many preferred embodiments of the present invention, the means for receiving and storing information is preferably adapted to transmit in a wireless manner an emergency call to one or more predefined persons and/or authorities in case one or more dose is not presented according to the stored time schedule or in case a missing but prescribed reaction from the user is detected.

Furthermore, the dispensing unit may preferably further comprise an interface for interfacing a medical appliance, such as an appliance for measuring blood sugar, pulse or the like, and for transferring data originating from such appliance to the memory means of the dispensing unit, and wherein the means for receiving and storing information is adapted to transmit such data in a wireless manner to medical authorities or nursing staff.

The dispensing unit according to the present invention may preferably further comprise interface means for electrical connecting to the dispensing unit external equipment for reading the content of the dispensing unit's memory, such as for reading the stored times of when particular doses are presented.

Dispensing of the dose may advantageously be controlled by predefined time schedules either being used as they are or being modified and in accordance herewith the dispensing unit may preferably comprise a number of predefined time schedules stored in the dispensing unit before any information is received and stored by the means for receiving and storing, each predefined time schedule prescribes a number of daily or weekly time windows for a limited number of dose types, e.g. 10, and wherein the location of each dose in the dispensing unit and each dose's time window are applied as a machine readable code a device used to fill the dispensing unit with doses.

Preferably, the dispensing unit according to the present invention may comprise activating means activating the dispensing unit, said activating means comprising an electronic reading unit for reading a tag or the like carried by and uniquely identifying the user of the unit by a battery less circuit to be read by the electronic reading unit (RFID), and said activating means is adapted to only activate the dispensing unit when a positive identification of the tag has taken place.

Manoeuvring of doses are perform by manoeuvring means which preferably comprises a closed loop conveyer with a conveyer belt having sections being flexible connected at their ends to form a close loop conveyer and wherein the conveyer belt comprise means for holding a dose. Alternatively, or in combination thereto, the manoeuvrings means may preferably comprise a closed loop conveyer with a conveyer belt having first sections flexible connected at their ends to second sections to form a closed loop conveyer belt, the stiffness of the first sections being higher than the stiffness of the second sections and the longitudinal direction, measured in the conveying direction, of the first sections being shorter than the longitudinal direction of the section sections so that the sections of the conveyer belt may travel in two parallel planes distanced from each other substantially by the longitudinal length of the first sections.

Preferably, wherein the conveyer belt, such as either the first sections or the second sections or both sections, comprise means for holding a dose. Preferably, the conveyer belt, such as either the first sections or the second sections or both sections, comprises upright members defining there between compartments for doses.

The means for holding a dose may preferably be constituted by one or more elongated members, preferably being cylindrical shaped, cone shaped or the like, adapted to co-operate with one or more cavities provided in a pack to be conveyed by the conveyer belt for carrying the pack while being conveyed.

Each dose in the dispenser unit is preferably contained in a pack according to the present invention.

Preferably, the dispensing unit comprises a ejection mechanism for ejecting a dose from the dispensing unit, when said dose is in the position where it can be presented to a user. Furthermore, the dispensing unit may preferably comprise a closing means for closing a dispensing opening in which a dose is presented to a user.

The present invention relates in a second aspect to a packing device for packing medicaments in predefined doses. Preferably, the packing device comprising a plurality of containers for containing medicaments,

said containers being arranged in shelves and each container has a delivery mechanism delivering a predetermined amount of medicaments when activated,

the packing device further comprising at least one remote controlled drone, e.g. self-propelling mechanical unit, having an actuator for activating the delivery mechanisms, said drone(s) being arranged on rails arranged so that the drone can be positioned so that its actuator may activate all delivery mechanisms and

said drone(s) has(have) at least one magazine chamber into which medicaments delivered by the delivery mechanisms are collected.

Preferably, the packing system comprising a plurality of drones which number may be changed. The system has the advantage, that it is scalable simply by adding more drones.

The delivery mechanism is preferably mechanical driven and the actuator is preferably adapted to drive delivery mechanism by applying a mechanical force to the delivery mechanism, so as to avoid further supply of energy to the delivery mechanism.

In preferred embodiment of the packing device, the device comprises preferably a number of assortment chambers each preferably having room for a plurality doses of same kind of medicine or for a plurality of multi-doses for a particular user of medicine, and wherein each of these collecting chambers within the same period of time may receive medicaments for a number of users of medicaments from one or several drones.

The packing may preferably comprise a wireless control network adapted to remote control the drone(s), said wireless control network is preferably embodied similar to wireless network used for data transmission for personal computers.

Preferably, the rails comprising turntables, switches and/or sidings for allowing drones to pass each other.

The packing device may preferably further comprise a device for evacuating packages in which the collected medicaments are placed in an inactive atmosphere and for subsequently sealing these packages. Alternatively or in combination thereto, the packing device may preferably be operating in an evacuated environment.

In order to apply information to packages, the packing device may preferably further comprise a printing unit for printing an identification tag and information in general in direct readable form to the user of the medicaments on an evacuated and sealed package.

Further, the packing device is preferably adapted to applying information in the form of bar codes on, magnetic coding on or the like or storing in a memory of an evacuated and sealed package.

The present invention relates in a third aspect to a pack for a medicament in form one or more pill or the like, which medicament is to be dispensed at one time. Preferably the pack provided by

a supporting structure having one or two openings each being closed in a sealed manner by a deformable sheet-like material,

wherein the material of the supporting structure and the sheet-like material are chosen so that when the pack is evacuated then no substantial deformation of the supporting structure occur and a substantial deformation of the sheet-like material occur resulting in that the medicament in the pack is fixed within the pack.

Preferably, the supporting structure comprises one or more cavities each adapted to co-operate with an elongated member, preferably being cylindrical shaped, cone shaped or the like, for carrying the pack while the pack is being conveyed.

The sheet-like material is preferably tubular shaped and the supporting structure is arranged in the interior of the tube. Preferably, the sheet-like material is having one or more initial open ends extending beyond the extension of the supporting structure, said open end(s) being sealed to form a sealed pack. Preferably, these open end(s) is(are) sealed by folding and fixing, preferably by gluing, welding or the like, the fold to the supporting structure so that the contour of the pack is substantial equal to the contour of the supporting structure. The pack may advantageously be evacuated before sealing.

It preferred to ensure the gas present in the pack or remaining in the pack after evacuation thereof is substantial constituted by an inert gas.

In a preferred embodiment, the pack according is prism shaped. The supporting structure may preferably be frame shaped or the supporting structure may preferably be constituted by a lid-less container.

The present invention relates in a fourth aspect to a central medication database system adapted enable controlling medicine dispensed by a medicine dispenser according to present invention. Preferably, the system being interconnected to pharmacies or other drug distribution centres and being adapted to maintain routing of alert calls either via a wired or wireless communication or a combination thereof and being connected, at least temporarily to said dispenser. Preferably, the dispenser is connected to the data base system via the Internet connected.

The central medication database is preferably adapted to update the database concurrently of the medicine dispensing actually performed in each and every pill dispenser connected to the database.

Furthermore, the central medication database system is preferably adapted to in case the medicine user did not take the medicine in a prescribed time window alert health care persons or relatives, preferably by mobile telephone.

The central medication database system is preferably adapted to adjust packaging of doses at the pharmacy or medicine packaging central of the next-to come multi-dose distribution packet for a particular medicine user with respect to medicine in the pill dispenser, that has not been taken at proper time.

In case medicine contained in a particular dispenser should not be reused or the dose is changed, the system is preferably adapted to download into the particular dispenser a new medication strategy, which strategy may preferably include deposition of obsolete dose packets in the loader at the next loading of the dispenser, as well as adapted to automatically and preferably via Internet to inform the pharmacy or unit packaging the medicine about change of medication and the possible immediate requirement of a new distribution packet with changed contents.

Preferably, supervision of medication may be established by adapting the system to automatically reporting of non-compliance in the intake of medicine by a user, which non-compliance being detected by detecting doses not being taken.

In the following, the present invention and in particular preferred embodiments thereof will be described in details with reference to the accompanying figures in which:

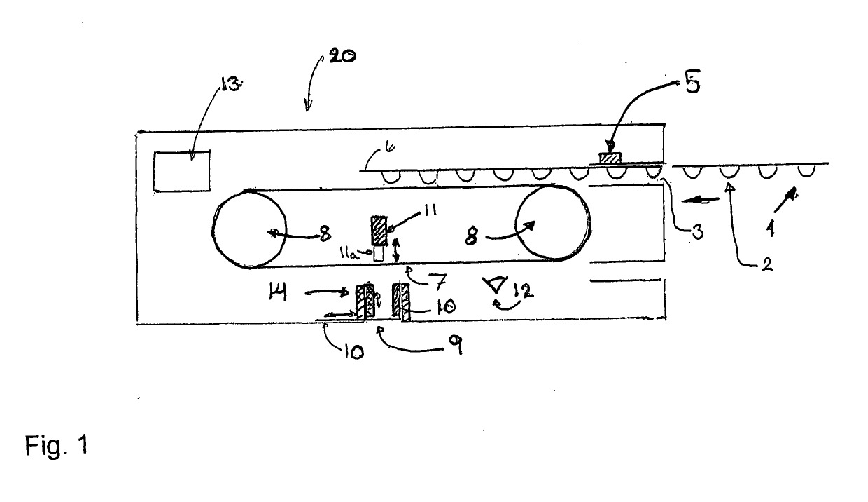

FIG. 1 shows schematically a preferred embodiment of the medicine dispenser according to the present invention where the medicine is contained in a strip or the like;

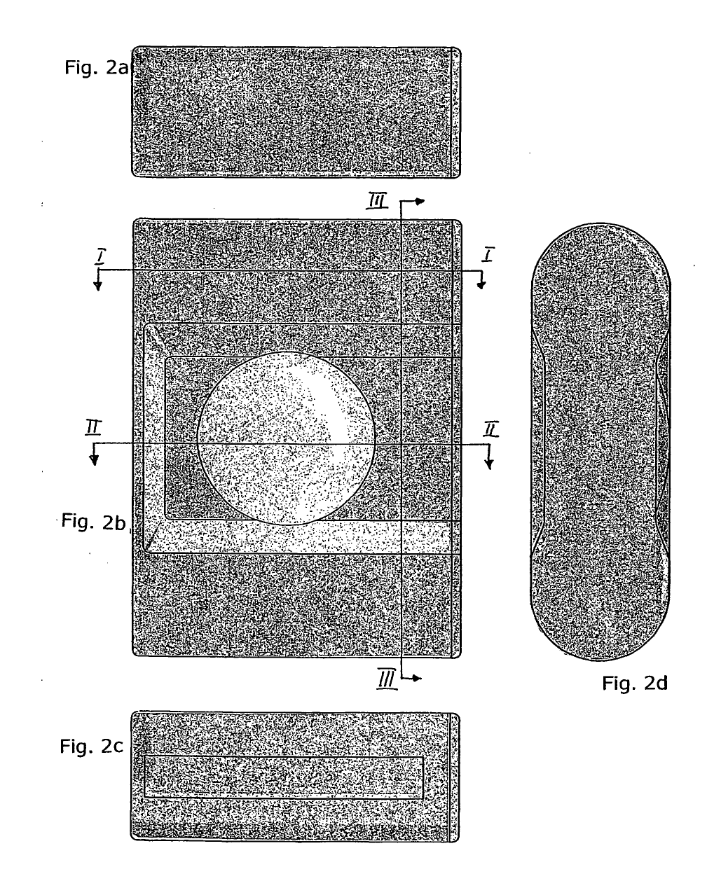

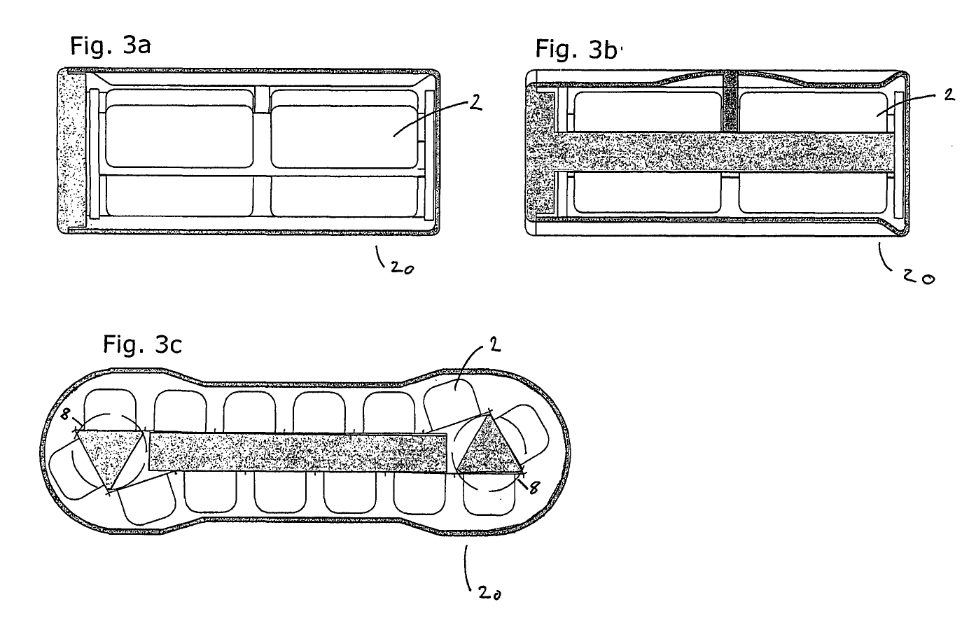

FIG. 2 shows schematically a preferred embodiment of the medicine dispenser according to the present invention, (the views are seen from the outside of the dispenser). FIG. 2a shows the dispenser from the left side, FIG. 2b shows the dispenser from the top, FIG. 2c shows the right side and FIG. 2d shows the dispenser from the back. The cross sections indicated in FIG. 2 are shown in FIG. 3 (cross section I-I is shown in FIG. 3a; cross section II-II is shown in FIG. 3b and cross section III-III is shown in FIG. 3c);

FIG. 3 shows three different cross sections of the medicine dispenser shown in schematic form in FIG. 2;

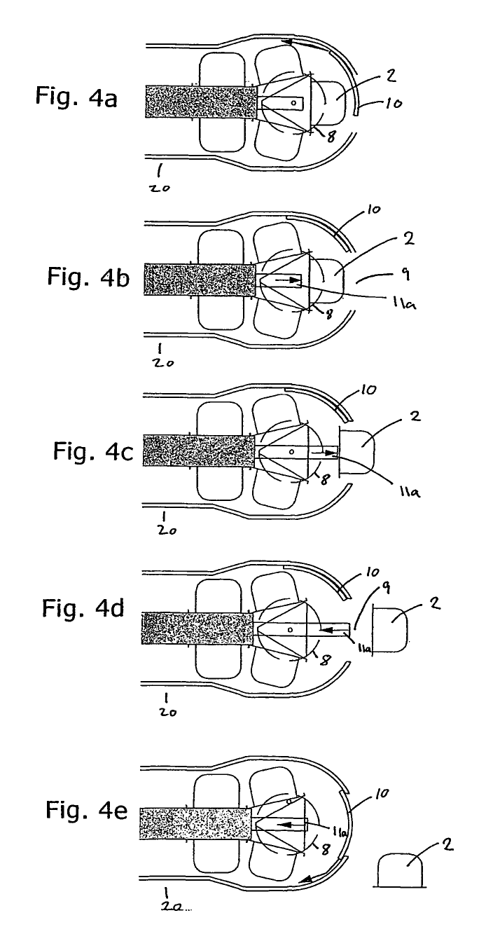

FIG. 4a to 4e shows examples on dispensing of a blister package by the use of a dispensing means;

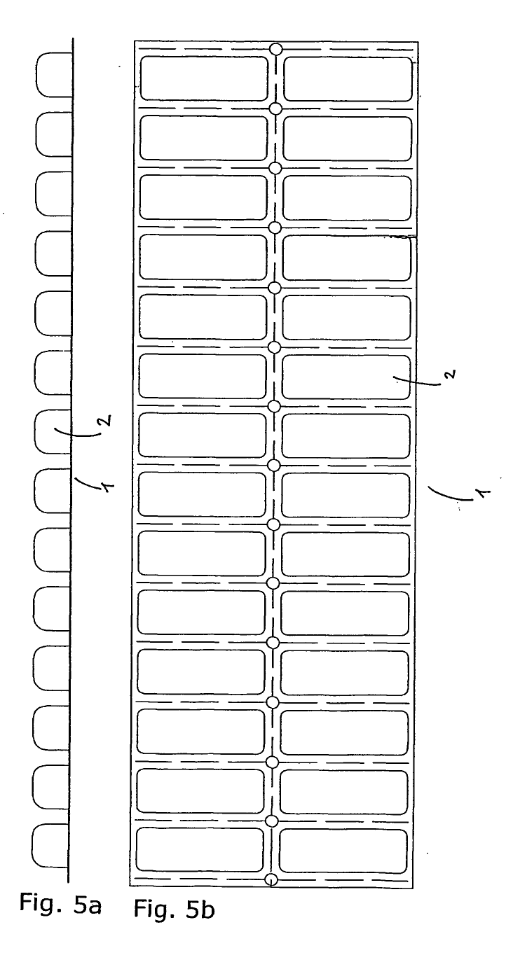

FIG. 5a and b. Shows in a schematic form a strip that is usable with the medicine dispenser according to the present invention (FIG. 5a is a front view and FIG. 5b is a top view);

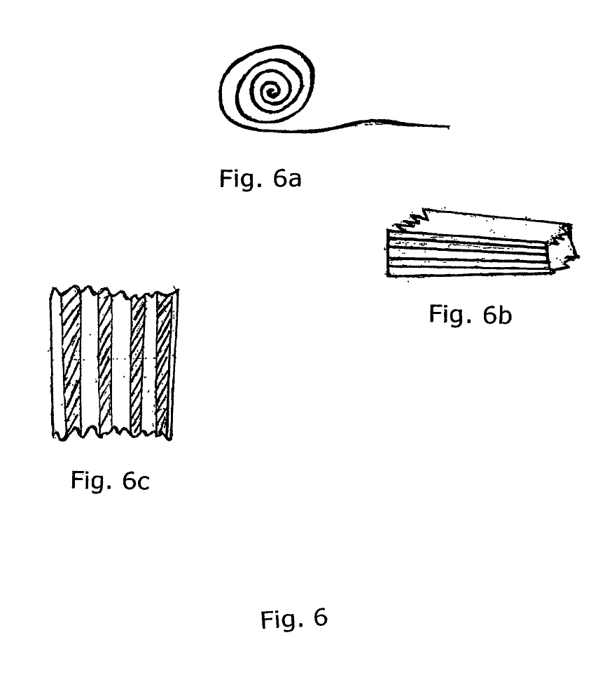

FIG. 6. Shows in a schematic form different Wrigley dose packets usable with the medicine dispenser according to the present invention, FIG. 6a shows a coil having a thin layer of medicine without filling material encapsulated in an eatable foil, FIG. 6b shows a laminate of medicine foil and FIG. 6c shows a foil having active fields (morning, noon, night . . . );

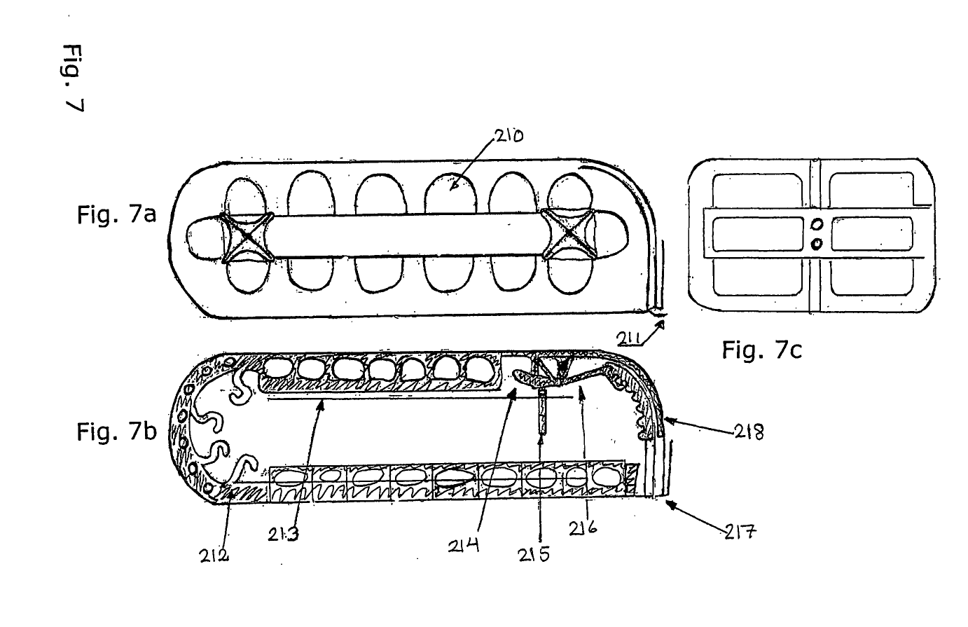

FIG. 7 Shows in a schematic form an embodiment of the medicine dispenser where the medicine is contained inside a packages or the like. FIG. 7a is a side view wherein (210) indicates dose packets and (211) indicates a guideway for louver gate. FIG. 7b is a cross sectional view in which (212) indicates spring for conveying dose packets, (213) indicates ribs, (214) a toggle switch, (215) a pawl from the CPU plug in, (216) a knee joint, (217) a guideway for auto load preferably co-operating with a shipment packaging of doses, (218) a louver gate. FIG. 7c is frontal cross sectional view of the dispenser;

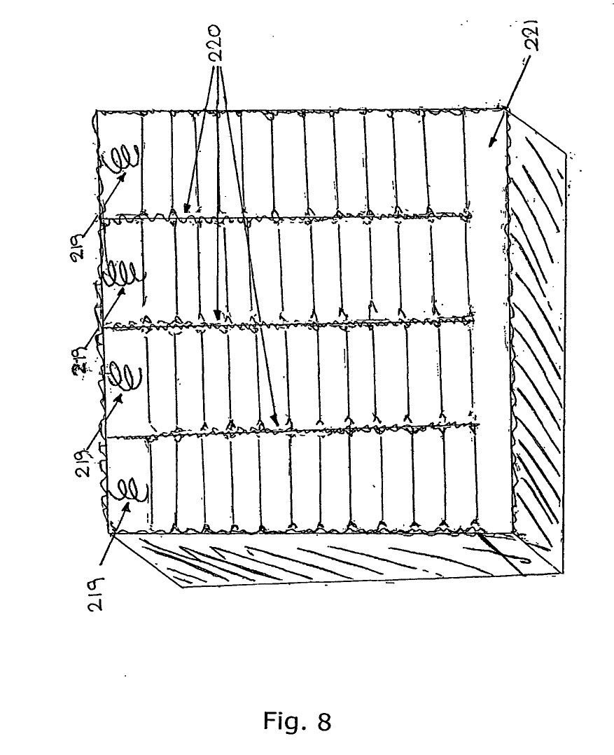

FIG. 8 Shows in a schematic form an embodiment of a pater noster oakum according to the present invention wherein (219) indicates springs for conveying stacks, (220) indicates wall for separating stacks and (221) indicates a cabinet for housing batteries, mechanics and electronics;

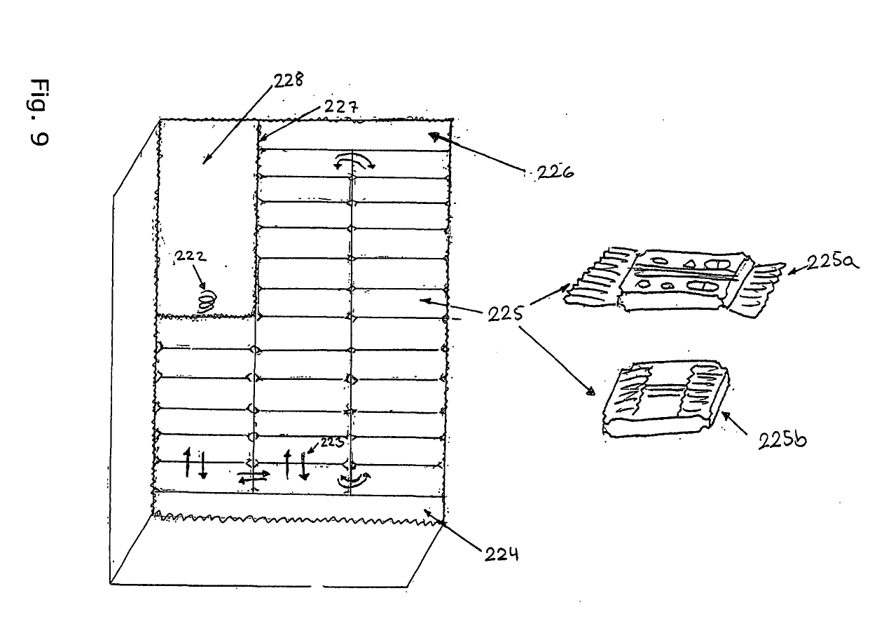

FIG. 9 Shows in a schematic form an embodiment of a pater noster oakum with a medicine package according to the present invention wherein the arrows (223) show the conveying direction of dose packets. (222) indicates a spring pressing the stack upwardly, (224) fixed pater noster oakum mechanics, (225) indicates dose packages and in particular (225) indicates a frame in which pills are placed in a bag and (225b) indicates the package in which the flaps of the bag are folded and glued, (226) indicates relocatable pater noster oakum mechanics, (227) separating wall and (228) indicates a compartment for electronics and batteries;

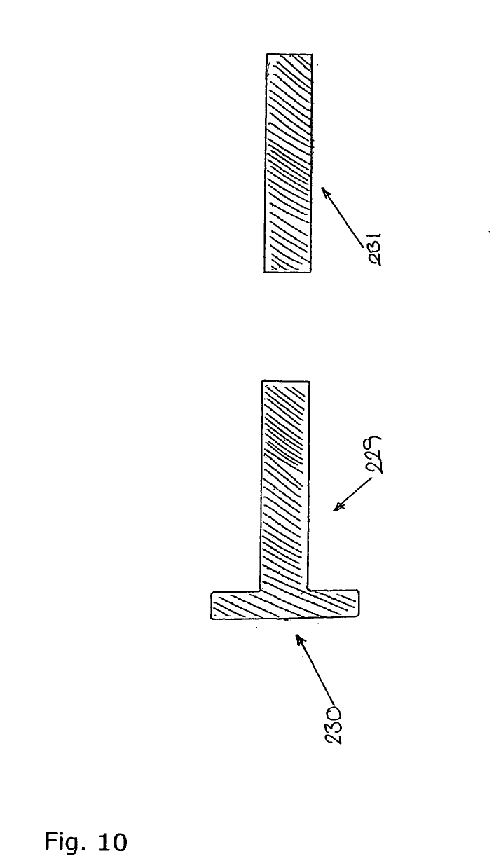

FIG. 10 Shows in a schematic form an embodiment of a CPU-plug-in according to the present invention wherein (229) indicates CPU-plug-in for strip model with cassette, (230) indicates side cabinet on CPU-plug-in for inserting in cassette and (231) indicates CPU-plug-in for strip model with auto load;

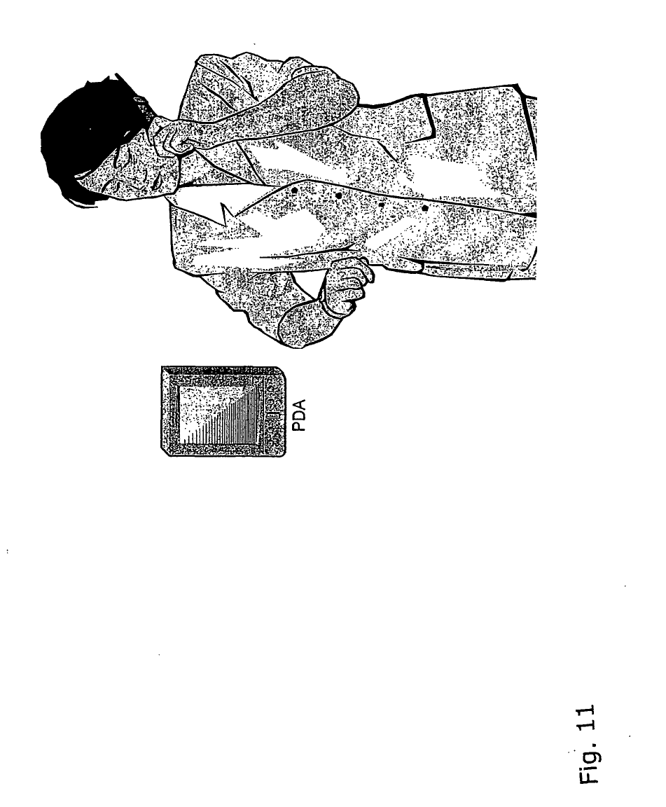

FIG. 11 Shows in a schematic form the use of a medicine dispenser according to the present invention made as a personal digital assistant (PDA);

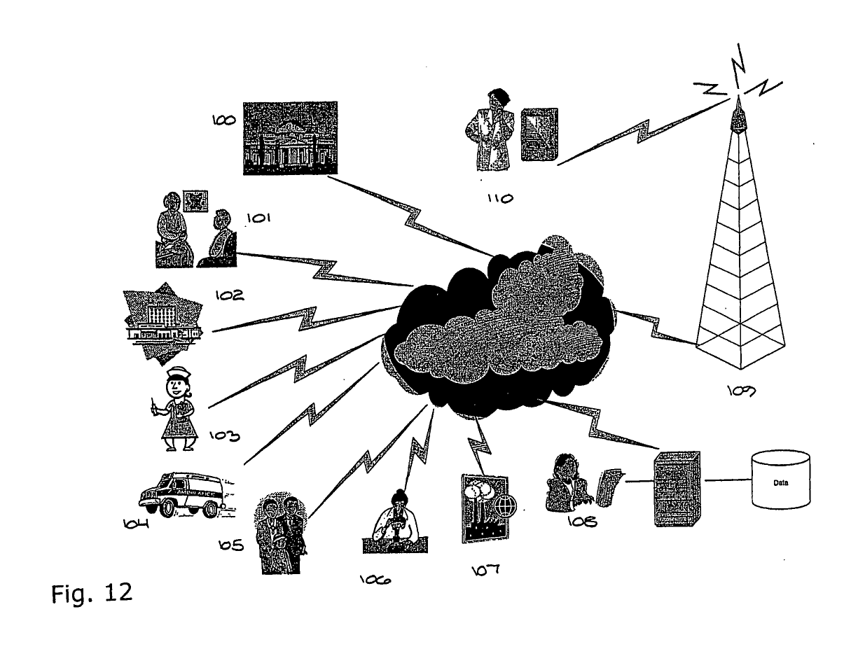

FIG. 12 Shows a scheme of communication facilities between a medicine dispenser according to the present invention and a number service organisations and interested parties, wherein (100) indicates a policymaker, (101) a doctor, (102) a hospital, (103) nursing care at home, (104) recovery truck, (105) family, (106) research, (107) industry, (108) alarm centre, (109) mobile transmitter and (110) indicates a patient);

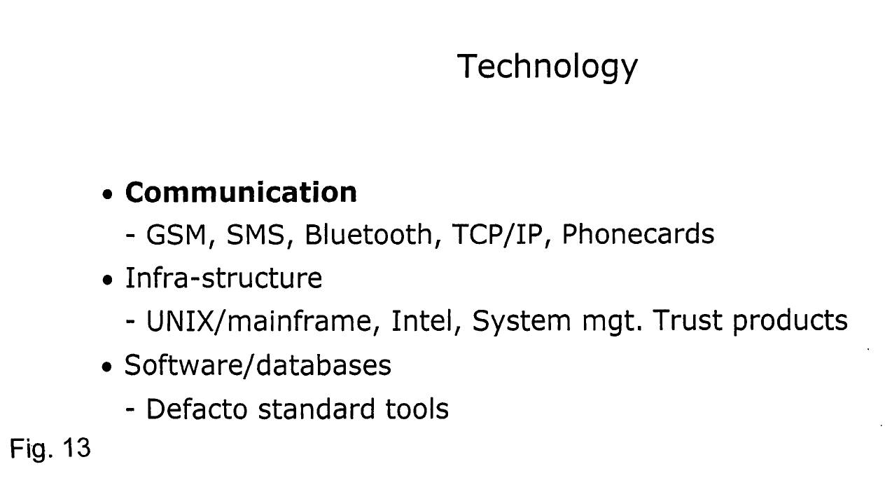

FIG. 13 Shows examples of communication technologies and software infra structure according to the present invention;

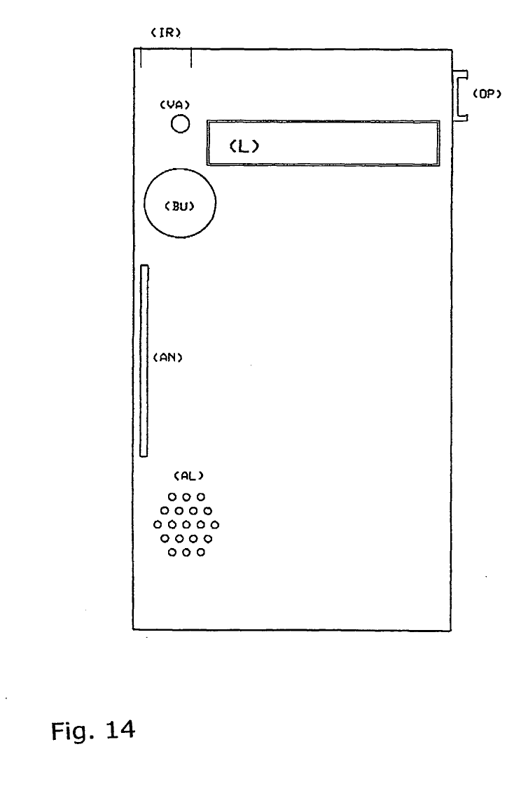

FIG. 14 shows a front view of a second embodiment of a dispenser according to the present invention;

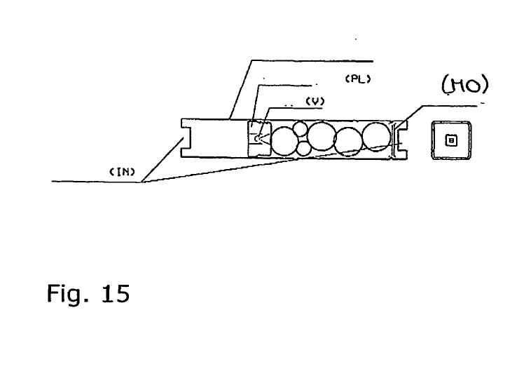

FIG. 15 shows a medicine packet container containing medicaments according to the present invention;

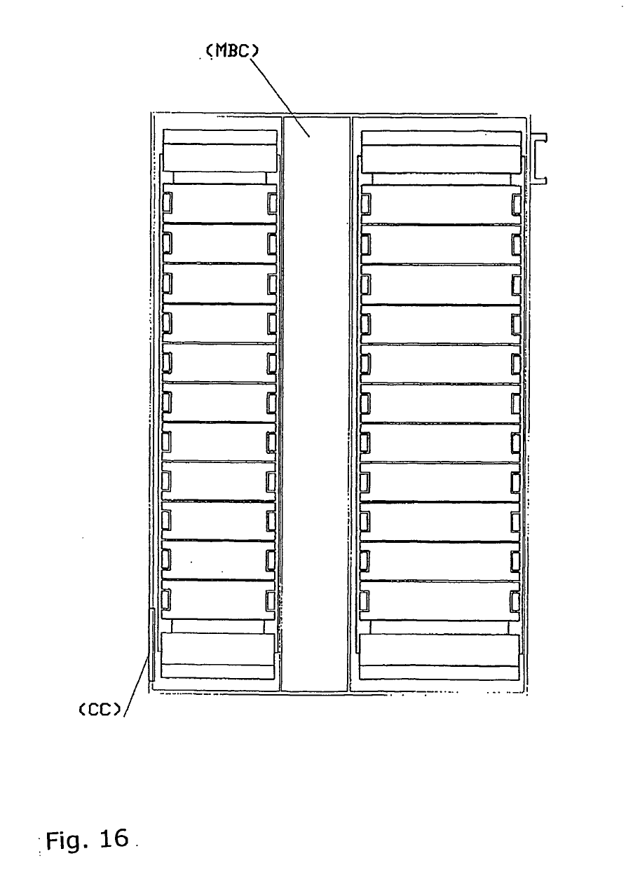

FIG. 16 shows from above the internal of the dispenser according to the present invention;

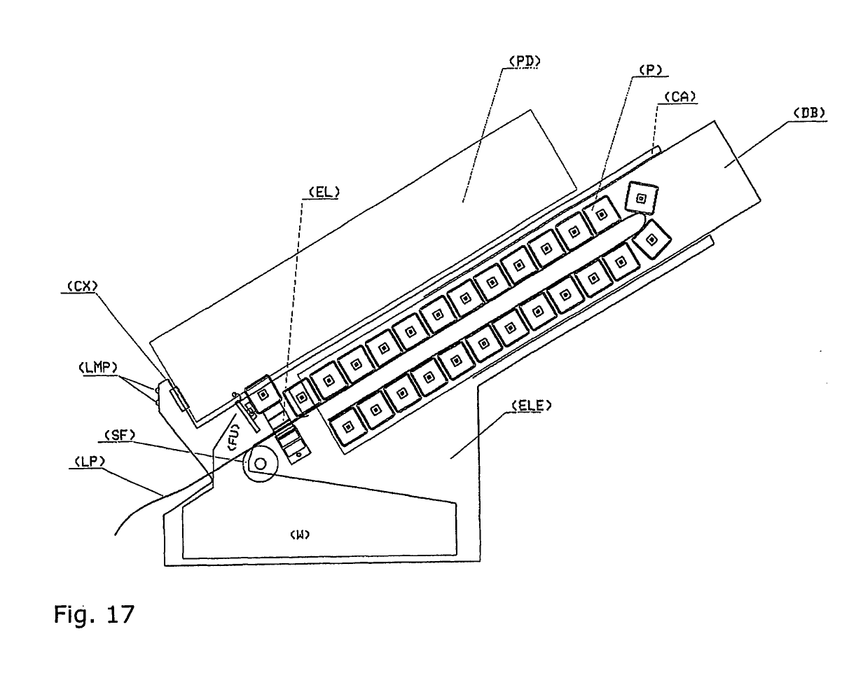

FIG. 17 shows loading of medicine into a dispenser according to the present invention;

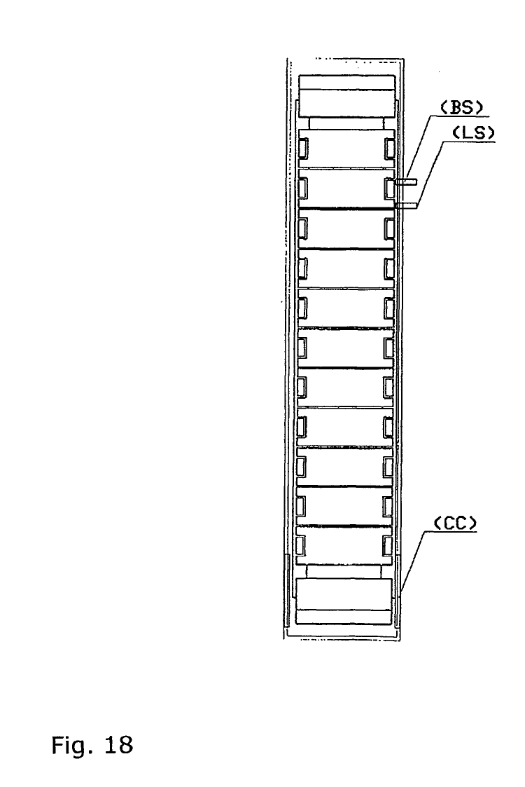

FIG. 18 shows belts of medicine dose packet arrangements in a dispenser according to the present invention;

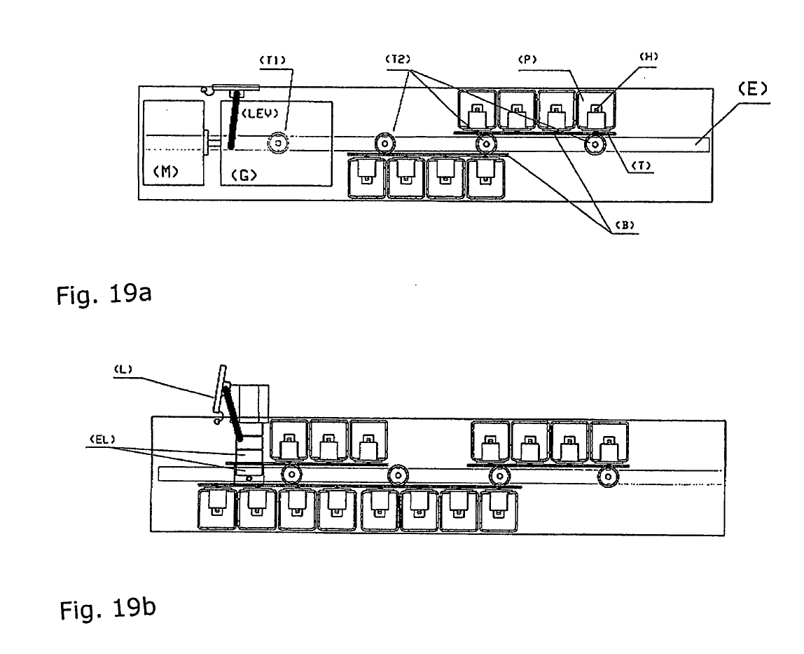

FIGS. 19a and b show sides view of the internal structure of a dispenser according to the present invention;

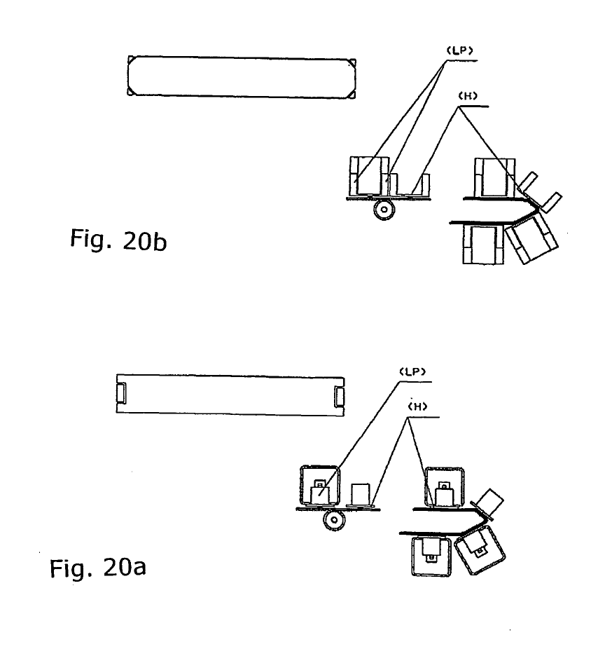

FIGS. 20a and b shows a close up view of the belt with packets within a dispenser according to the present invention;

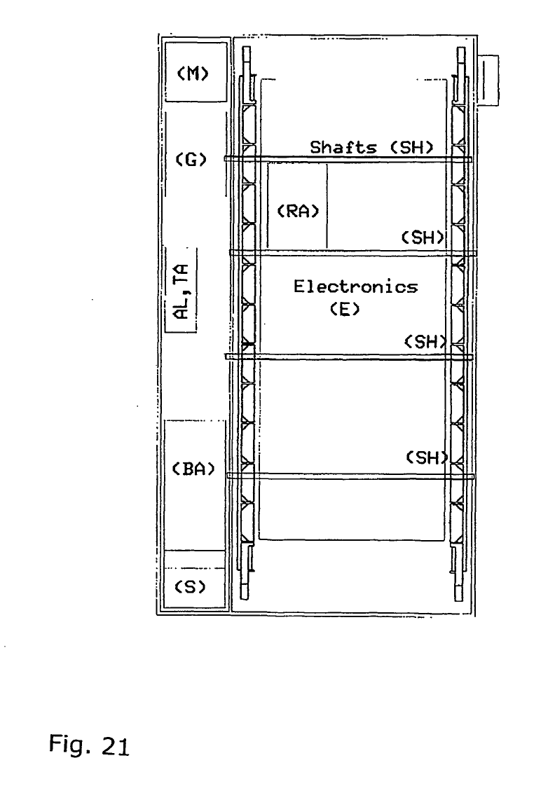

FIG. 21 shows from above the internal of the of the dispenser according to the present invention, in which the conveyer belt is removed for clarity;

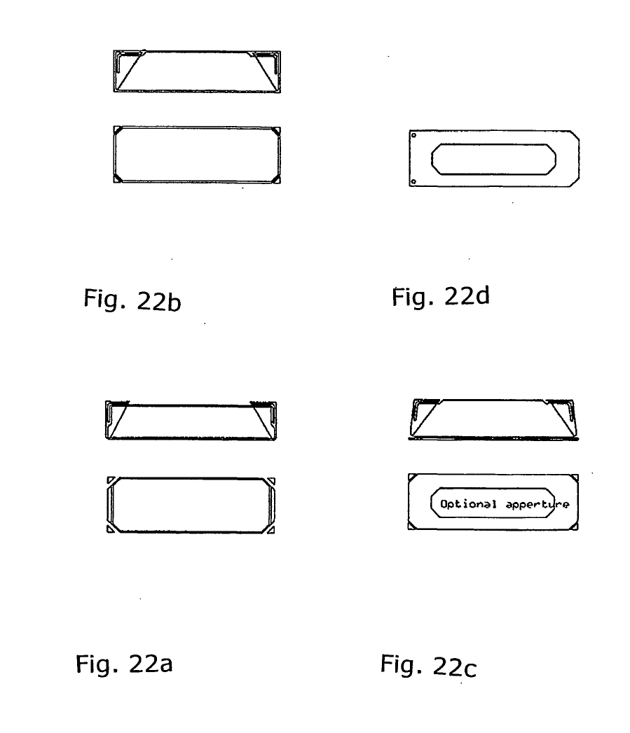

FIGS. 22a to d shows different embodiment of medicine dose packet arrangements according to the present invention;

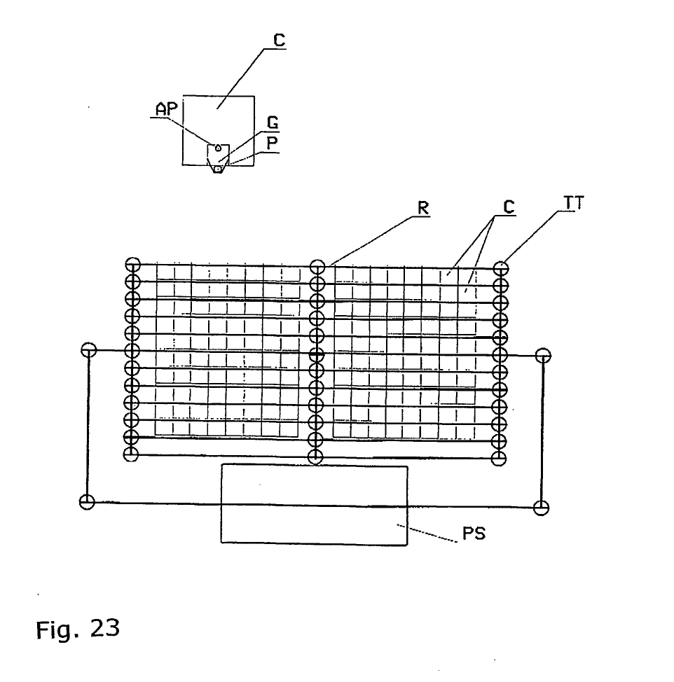

FIG. 23 show a preferred embodiment of a packing machines according to the present invention,

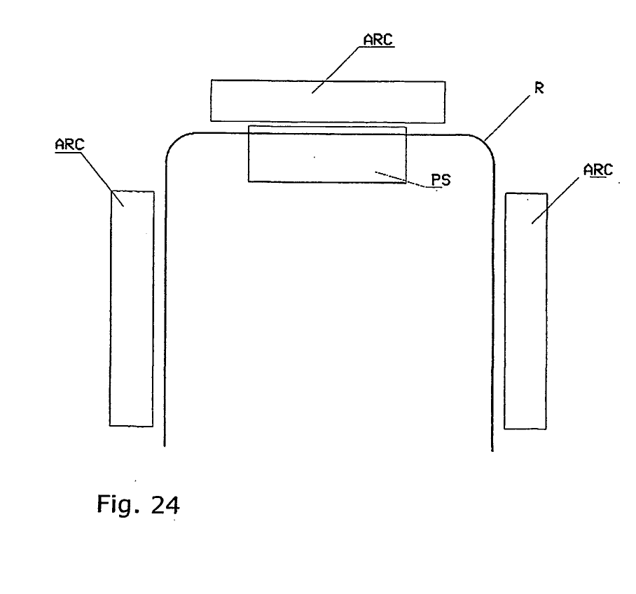

FIG. 24 show from above a preferred embodiment of a packing machine according to the present invention wherein the compartment arrays being vertical;

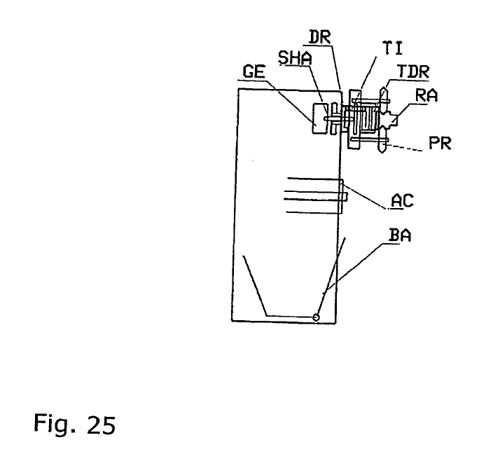

FIG. 25 shows the principle of a trolley (also termed drone) according to the present invention for collecting medicine;

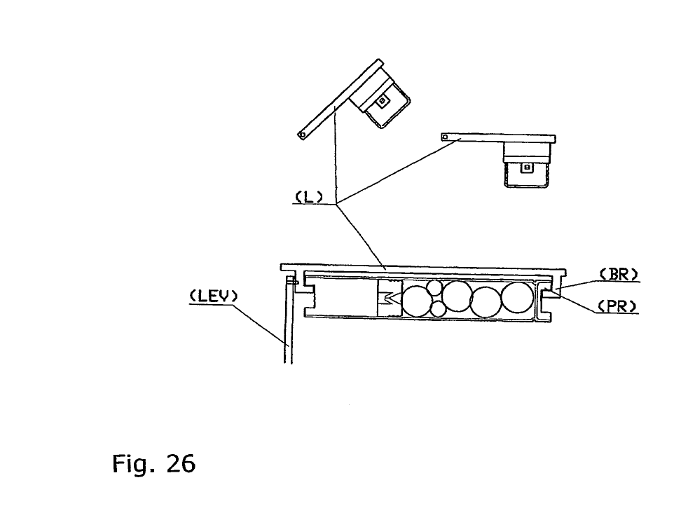

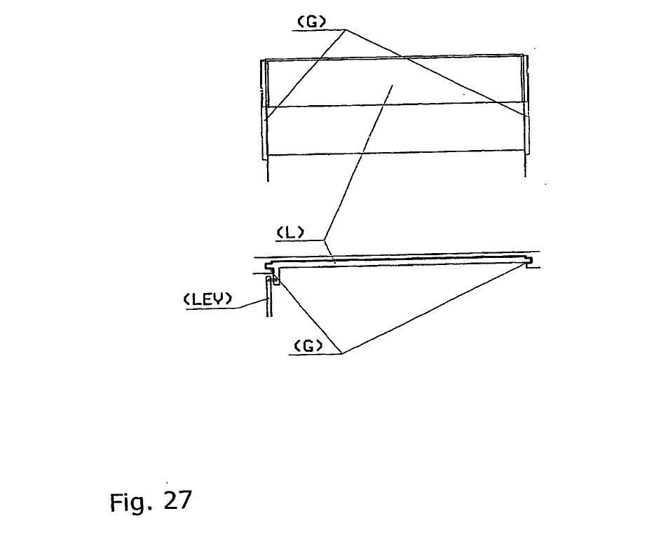

FIGS. 26 and 27 show different ways of ejection medicine dose packet from a dispenser;

Some of the preferred embodiments of the present invention may briefly be characterised by that the:

medicine is packed inside a strip that when inserted is drawn into the medicine dispenser by to spokes inside the cabinet;

medicine is contained inside packages that after they are inserted into the medicine dispenser will be rotated in a pater noster work with or without a side kick chamber;

medicine packed as a “Wrigley”, meaning that the medicine is placed a tape, which is inserted into the medicine dispenser. The “Wrigley” is mainly made from thin layers of medicine coming from spools inside the packaging machine.

However, as will appear from the following description, the above is not a complete list and some of the preferred embodiments of the present invention, have characteristics differing from the ones of the list.

A First Embodiment

FIG. 1 depict in a schematic form the inside of a medicine dispenser according to the present invention, where the medicine is packed inside a strip. As shown in FIG. 1 the strip is inserted 1, where the medicine is contained in blister packages 2, into the medicine dispenser 20 through an insertion opening 3. This insertion opening 3 include mainly reading means 5 connected to a CPU 13 to read information 6 attached to the strip, so when the strip is inserted to the medicine dispenser 20 then it passes the reading means 5, that thereby reads and transfer the information from the strip 1 to the CPU 13.

The strip 1 is thereafter received by a transport system including a conveyor belt 7 and spools 8, of which at least one of them is driven by a CPU 13 controlled motor. In the in FIG. 1 depicted embodiment of the present invention the conveyor belt includes pins (not shown in the figure), that fit into grooves or holes in the strip 1, so the strips position relative to the conveyor belt 7 is fixed.

Movement of the strip inside the medicine dispenser 20 is controlled by the CPU 10, that also contains memory for data storage. The strips position relative to for instance the dispensing means is detected by a detection means 12, so the position of the strip inside the medicine dispenser is always known. Alternatively or as a supplement to this, the conveyor belt is made as a tooth chain and the spools 8 are made as cogwheels. By designing the transport mechanism in this way it is possible to secure that one turn of one of the cogwheels 8 will result in a clearly defined advancement of the strip 1. Control of advancement and dispensing of medicine is described more in detail below.

When the medicine must be dispensed a blister package 2 containing the medicine to be dispensed is advanced to the dispensing means 14. This dispensing means includes a moveable part 10 that during dispensing is moved towards the conveyor belt 7 and create a counter pressure to counteract a pressure informed by a piston or the like 11a on a blister package to press out the medicine in a way so the strips position relative to the conveyor belt remains more less unaffected during the medicine dispensing action.

The dispensing means 14 includes furthermore a closing mechanism 10 to block the dispensing opening 9, that in closed mode prevents foreign bodies from entering the medicine dispenser, and that is opened automatically when the medicine is pressed into the dispensing means 14.

An alternative to the above dispensing means which will be described in detail below is a dispensing means which dispense an entire blister package 2 instead of pressing the medicine out of the medicine package 2 inside the medicine dispenser. This is particularly advantageous because this prevent contamination of the medicine as the result of forceful handling of the medicine and because there is no need to use space inside the medicine dispenser to contain emptied blister packages. D

Different embodiments of medicine packages usable in relation with the present invention can be grouped as seen in table 1 below.

A Second Embodiment

In accordance with a the invention the embodiment described in the following relates to a dispensing system, where the medicine, being single pills or multidose for distribution at the same time, is contained inaccessibly in the dispenser until the proper time for disposal, which is indicated by an alert signal by one or more means: visual, acoustic or vibration as well as via remote means, such as wireless communication. See FIG. 14

When alerted, the medicine user acknowledges by pressing a button (BU), which makes the dispenser mechanism open a lid (L) and present a medicine packet to the user. In case of more pills in a single dose, than the dose packet, FIG. 15, can contain, or in case of cross contamining medicine, the dispenser will dispense the adequate number and type of packets at the same dispensing operation in response to the users acknowledge signal. Furthermore, if the user does not acknowledge the alert signal within due time the dispenser will not allow dispensing of the dose packets and furthermore keep the packets inside the dispenser inaccessible to the user. The packets withheld in this way may be later dispensed at due time in accordance with the dispensing strategy controlled by the information storage and processing capabilities in the dispenser.

In the preferred embodiments of the invention, the dispenser has means for wired or wireless communication to a central medication database (CMD), which, via connections to Internet and suitable application software allows all parties, including, physicians, hospital departments, clinics, pharmacies, healthcare personnel and relatives to share information on the medicine compliance of the user. This includes:

Prescription of information from and to the medical agents: physicians, clinics and hospital departments.

Required medication packaging to pharmacy or medicine distribution centers.

Information regarding proper intake scheduling and identification of individual doses to the medicine dispenser

Information regarding the medicine users possible adverse compliance to the medical agents and health care personnel and relatives in cases of life supporting medicine compliance.

Information regarding possible non-used dosepackets and their nature for reuse and proper salvage e.g. by leaving out corresponding dosepackets in subsequent deliveries of dosepackets for filling up the dispenser.

In preferred embodiments, the dispenser is automatically filled up in a loader machine, FIG. 17. The advantage of using a loader machine is, that the medicine users and other persons access to the dose packets is prevented to a high degree. The loader also allows the removal of packages from the dispenser and facilitates loading of the dispenser in case of disabled persons. In the preferred embodiments of a loader machine, the loader is equipped with a closed compartment that is used to collect medicine packets that have not been dispensed and cannot be reused, either because the medication has been changed, or because the lifetime of the medicine has been exceeded. The closed compartment may be emptied by means of suitable tools be qualified personal e.g. at a pharmacy or by the staff of a hospital department or clinic. Alternatively the closed compartment may be emptied into the distribution container after loading of the medicine into the dispenser and the distribution container subsequently returned to the medicine distributor for refinery and reuse or destruction. The closed compartment may preferably be designed as a removable box, so that the wasted medicine may be returned for destruction.

In the preferred embodiments, the communications means between the medicine dispenser and CMD is located in the pill dispenser which again is connected to the CMD via well known means using wired communications and fixed wire telephone modems or well known wireless communications means such as Wireless LAN, Bluetooth, IRDA, Datacommunications via Cellphone modems and other wired or wireless communication used in office, factory and home automation, such as JEMA, X-10.

It should be emphasised, that although the dispenser described herein is described with focus on medicine it could be used for all other things, that would require regular and pre-ordered dispensing, e.g. anti-conception pills, contact lenses over-the-shelf medicine, cosmetics (as far as the space allows) dietetic supplement and similar. Furthermore, the invention is not limited to be used in health care or personal care environments, but could be used whenever items of suitable size and possible limited lifetime need to be regularly distributed and replenished in a controlled and carefully monitored fashion.

In the preferred embodiments of the invention the medicine dispenser can be optionally fitted with means for positively identifying the person promoting the dispensing of medicine. Such means for secure automatic personal identification may preferably be of well known types, and could be PIN codes RF identification means (wireless tags, RFID tags) biometric identification means like finger print readers, signature recognizers, iris recognizers and similar.

In an preferred application of the dispenser, the information storage and processing means and wireless communication capabilities to a central, internet connected CMD can further be exploited to provide a means for distributing medicine in a hospital department or clinic. In such applications, the medicine dispenser is used to dispense medicine at a given time of day to many different patients. The CMD connection, information handling and identification means are particularly suited in this application, not only to ensure that the right person is actually distributing the medicine but also to ensure, that the positively identified patient are given the correct medicine dose packet, and that the medicine intake may be positively acknowledged.

In a particular preferred embodiment of the invention, the medicine dispenser is designed with belts of medicine packets one either side of the motor/battery compartment (MBC) as indicated in FIG. 16. Using this embodiment, the shape of the dose packets and the dispenser may be more freely chosen eventually resulting in a more compact design. This embodiment comprising two openings and associated lids for presenting the medicine packets and associated opening mechanisms, which may be designed as described for the single belt version.

Further belts of medicine dose packet arrangements (FIG. 18) may be added parallel to the first and all belts and associated openings and lids may have different width, thus leading to a more flexible distribution of size and shape of the medicine dose packets. Power and steering is accomplished through belt shaft (BS) and Lid shaft (LS) as well as contact arrangement (CC) for indication of belt positioning.

The design of the loader mechanism has to match the number and sizes (width's) of belts according to this embodiment.

The dispensers information communication and processing capabilities may preferably be used to adapt the dose presented to the medicine user to requirements based on diagnostics measurements carried out on the medicine user either in his/hers home, at the physician, at the clinic or at a hospital department or similar.

The diagnostic measurements may as soon as data is transferred between the diagnostic device, the central medicine (CMD), possibly via the referring physician and again via the database and communication connections back to the dispenser be used by the dispenser to change the medication accordingly.

The change of medication may be accomplished by holding back a medicine dose packet, by distributing more dose packet with suitable contents.

In the case only one or a few drugs are administered to the same medicine user at the same time, these could be packaged in a systematic manner in order to obtain the right required dosage at any given instance by presenting the correct number of dose packets with the correct contents in the right time window.

In a further preferred embodiment of the pill dispenser and dispenser-loader system, the communications capabilities of these devices are preferably used to provide a means for communicating results from automatic diagnostic equipment, like heart monitors, blood-glucose monitors, blood pressure monitors end the like, to the database and, according to the application programs associated with the database to the referring physician.

A preferred embodiment of the medicine dispenser is shown in more detail in FIG. 19a and FIG. 19b, which embodiment comprising a belt having holders (H) for medicine dose packets (P). The belt is connected in a ring by means of a support belt (B) with the dose packets (P) exposed at the exterior of the belt. The flexible belts (B) are on the internal side equipped with teeth (T) mating tooth-wheels (T1 and T2) on shaft with bearings attached to the medicine dispensers fixed structure. At least one of these wheels (T1) in either side is engaged to a mechanical gearbox (G) and a motor (M) controlled by the built in microprocessor, whereas other tooth-wheels (T2) in pairs on a common shaft serve the purpose of transferring movement force from one side of the belt to the other and from the upper part of a tooth ring to the lower part of the ring. A battery pack (BA) is located adjacent to the motor and gearbox assemblies (removed on the drawing).

By means of a special arrangement depicted in FIG. 20, a, b, and accomplished by having the belt and the holder for the medicine dose packet attached solidly at a much smaller length of belt than the width of the packet in the direction of the belt, the medicine dose packets are allowed to move from the upper part of the belt to the lower part using very little room. This special arrangement is particular advantageous and allows the resulting medicine dispenser to be smaller (flatter) with less wasted space.

Again referring to FIG. 14, FIG. 19a and FIG. 19b and FIG. 21, the space between the upper and lower part of the belt is used for electronics (E) and traversing shafts (SH) for the tooth-wheels (T1 and T2), whereas a compartment along one side of the belt arrangement is used for motor (M), gearbox (G) batteries (B), acoustic alarm means (AL), visual alarm means (VA), tactile alarm means (TA) and possible identification sensor (S), which could be of any suitable kind including magnetic stripe readers, RFID tags, fingerprint readers or the like known technologies for personal identification.

A button (BU) to allow the user to prompt for the presentation of medicine is located on one surface, see FIG. 14.

With reference to FIG. 19b, presentation of the medicine takes place by opening a lid (L) in the surface, by means of an actuator arrangement in the gearbox of which the lever (LEV) is shown, allowing en elevating mechanism (EL), which could be a scissors jack or a screw jack or a similar known device for translatoric movements, to present the medicine to the user. Alternatively, the lid, by means of a pair of brackets (BR), extracts the medicine dose packet having suitable mating protrusions (PR), from the holder during the movement of the lid opening using the lever (LEV) and thereby presents it to the user (see FIG. 26). As a further alternative, see FIG. 27, the lid (L) slides to the side in guides (G) by operating the pushing rod (LEV) and dispose the medicine packet, which subsequently is pushed partly out of the opening using an elevator mechanism operated by index tooth wheels activated by a separate motor or by electromechanical controlled clutch mechanisms in the gearbox (not shown). It is envisaged that combination thereof is applicable in connection with the present invention

A contact arrangement (CO) provides means for connecting power and information connections to the unit, either directly via a charging device with communications interface or via the loader machine which also contains the charger. Advantageously, infra red communications interface (IR) may be located on the surface of the dispenser assembly and advantageously wireless radio interface (RA) may be located in the interior with an antenna (AN) as part of the enclosure. These interfaces will enable communication either with the loader using well known data communication means and hence the loader could advantageously be equipped with wired or wireless interface to the CMD. The communications interfaces in the pill dispenser are not limited to short haul IR or wireless interface but could be wired or use standard IRDA or Bluetooth protocols to mobile telephone, office equipment and similar or even consist of a standard datacommunication means like DECT or GSM or other cellphone communications means.

Medicine Packet

A preferred embodiment of the medicine packet is indicated in FIG. 15. The medicine packet comprises a supporting structure shaped as a thin walled rectangular tube (TU) with indents (IN) matching the lockpin (LP) of the holder (H) of the belt arrangement shown in excerpt in FIG. 20a.

In another preferred embodiment, the holders are assigned with two lock pins (LP) in the corners, as indicated in FIG. 20b, where the shape of the mating dose packet is also shown. This design of the packet shape is particularly useful for foil wrapped packets, see below.

The rectangular tube is closed in one end by a moulded lid (MO) but with grooves moulded in three or four sides of the plastic to allow the end piece to break open when subject to a modest torque applied using the opening device (OP) of FIG. 14. This is merely a hole with two sharp opposite edges.

The medicine packet container is closed by a plug device (PL) with a built-in on-way ventilation arrangement (V) that allows confined air to escape, but prevents in particular oxygen as well as other gasses to enter the confined compartment with the medicine pills.

When packing the medicine, the tubular plastic packet is filled with an inert gas before the seal is applied and the sealed tubes subjected to vacuum, which will suck out surplus gas and make the seal compress the medicine pills gently an prevent rattling and wear of the pills surface during shipment, handling and time in the dispenser.

When loaded, most or all positions on the belt will hold medicine packages. During the loading process, the dispenser retrieves information on the proper identity of the addressee of the medicine to load and match that with stored information on the identity of the owner of the dispenser. If validation is successful, information on the dispensing schedule is retrieved from the CMD via the communications means and stored in the dispenser. If access to the network is not available, reduced information on default dispensing strategies are read using optical, magnetic or other suitable means from the tape of the distribution packet. Hence it is ensured, that safe but not always optimal medication (if using the default strategy possibly) can always be carried out by the dispenser.

Based on the strategy information stored, the dispenser will alert the user at every proper time, while moving the belt to ensure, that the correct (multi) medicine dose packet for that time is available adjacent to lid. If the patient press the acknowledge button (BU) prompting for the medicine, before the time window for this medicine dose ends, the lid will open thereby presenting the medicine to the patient which may pick up the medicine dose packet, open it using the opening tool (OP) of FIG. 14 and pour out the pills in the hand or on a plate. The plastic tube is subsequently discarded.

To provide additional verification that distribution is correct, the medicine dose packet tubes may be coloured with easily distinguishable colours for given times of the day. If the patient does not prompt for presentation of the medicine packet before the end of the time window, the dispenser will cease to present the medicine dose package, and the package remains in the dispenser.

Depending on the instructions received from the CMD and originally prescribed by the physician the retained medicine dose package may be presented again in due time or kept inside the dispenser for later removal from the dispenser either by qualified personnel or via the loader.

Medicine Dose Package Made of Foil.

The preferred embodiment of the medicine package described above comprising an injection moulded plastic tube (which in broad terms are called a supporting structure) having a seal. In another preferred embodiment the package comprising a frame which also may be termed a supporting structure. The frame is preferably injection moulded or a flat possibly punched piece of cardboard or plastic, see FIG. 22, a, b and c. A thin-walled or (co-) extruded plastic foil tubing (preferably be laminated) similar to what is used in the food industry is packaged around the medicine and the frame, where after the thereby defined container is evacuated and welded to seal the package (the welding may preferably be like the one used for sealing e.g. chocolate bars).

The welded ends are folded and glued in order for the resulting somewhat irregular package to be as compact as possible, and still complying to given size limits in all directions, see FIG. 22.a.

The final package is held in place in the dispenser by pins in the holder guiding the package in the dispenser by pressing against the frame through the hermetic foil. In an alternative embodiment the frame is placed outside the evacuated, welded, folded and glued foil package and either the frame has walls and possibly a bottom and the foil package is placed inside the frame FIG. 22.b or the frame is two-dimensional and the foil package is glued to the surface of the frame FIG. 22.c.

In a further preferred embodiment, an external frame, being two- or three-dimensional has a flange in one side in the bottom part with two holes in adjacent corners. These holes mates corresponding pins in the holder attached to the belt. Only one belt is normally required in this embodiment, whereas the other end is confined to a groove in the enclosure.

It is preferred, in all cases, that the final package is ensured to comply to the maximum size allowed by the dispenser by the application of proper moulds during the packaging process.

A presently most preferred holder arrangement for multidose packets made of foil, is the one depicted in FIG. 20b, however the foil packets may also be adapted to the holder of FIG. 20a, or other suitable holder shapes.

Loading Medicine

In another aspect, the present invention preferably comprises and/or relates to a loader machine for loading medicine into the to medicine dispenser. Referring to FIG. 17, the loader machine uses dose packets (P) arranged on a tape or belt (TP) and packaged in one or more layers in a serpentine fashion in a preferably disposable cardboard or plastic distribution box (DB), although the invention also preferably includes the use of recycled distribution boxes that may be used with or without a loader machine, e.g. by manually operating a suitable mechanism on the distribution box, that transfers the packets one or more at a time to the dispenser.

In preferred embodiments, the loader contains a cavity (CA) that mates the distribution box after a sealing strip has been removed, preferably automatically. The pill dispenser (PD) is placed in the loader face down, and the pill dispenser now operates its dispensing mechanism in a way to empty those dose packets that should no more be used. These packets are caught by the funnel (FU) and deposited in the waste compartment (W).

This emptying process takes place before a distribution box has been inserted into the loader. The user is prompted, e.g. by a lamp and/or acoustic signal, that insertion is required. An electromagnetically or mechanically operated interlock (not shown) prevents insertion of the distribution box until the pill dispenser has been unloaded of not reusable doses.

A leading perforated part of the tape (LP) carrying the dose packets in the distribution box is caught by one or more sprocket feeder wheels (SF), in a way similar to the way, that automatic film loaders for cameras operate, and the dose packets are one by one inserted into the pill dispenser in vacant medicine packet holders using an elevator mechanism (EL), which could be a miniature scissors jack, a lead screw or similar known devises suitable for translatoric movements.

When loading is complete an alerting signal and associated indicator lamps (LMP) on the loader indicates, that the pill dispenser may be removed. Another indicating lamp or lamps tells the user about the charging state of the pill dispenser's batteries. The indicator lamp tells the user and the CMD when the box collecting discarded medicine packages should be removed and substituted.

Control electronics and communication electronics (ELE) is located inside the enclosure. A contact arrangement (CX) ensures contact for charging the dispenser and optional wired communication between the dispenser and the loader. An optional infrared interface (not shown) for communication with the dispenser or for IRDA communication to a PC or other means may be located on the outer surface of the loader.

Packing Machine for Multidose Medicine Packages

In another aspect of the present invention the invention relates to or comprises a packing machines for packing medicine into doses to be presented by a medicine dispenser or the like. Packing of doses, for example multidoses, are done in a flexible and fast manner. Furthermore, the packages are being packed in accordance with requirements of user specific multidose packages when using a medicine dispensing system in accordance with the present invention.

Typically, the packing machines may have a few hundred compartments to stock the same number of different medicine pills, including dose variations. The packing method according to the present invention is based on single active gates ejecting one single pill from a stock compartment to a single collecting tray. After all required pills have been collected in the tray the content of the tray is transferred to a final packaging section and eventually enclosed in a package.

With reference to FIG. 23, the packing machines according to the present invention fulfilling the requirements of the pill dispensers according to the present invention, are based on a large array of compartments (C) with passive gates (G), which when operated at the actuation lever (AP) eject a single pill (P). A system of vertical and horizontal rails (R) with teeth and interconnected with vertical 90 degrees turntables (TT) (railway terminology), to allow shift in the trolleys direction of motion, are positioned in a systematic fashion in front of the compartments. Several compartment sections may be connected flexibly and in angles, e.g. arranged in a lying U form with the compartment arrays being vertical as indicated in FIG. 24, where (ARC) are the arrays of compartments seen from the top and (R) indicates the rail system seen from the top. A common package station is also indicated, although the concept is not limited to one package station per package machine.

The collection of medicine pills from the different storage compartments is carried out by one or more in principle independent trolleys (also termed drones), FIG. 25, with brush contacts to specific power isolated power sections on the rails or with individual batteries for power supply, electronics, short haul wireless communications, electric motor(s), gears and a suitable tooth-wheel drive and clamp mechanism.

Due to the vertical movement, the rails and clamp mechanisms are designed such that a trolley is kept in place on the rail, much like hanging monorails, but, due to the tooth-wheel rail, capable of motion in the vertical direction.

Due to the many turntables and cross points, the trolleys may easily pass each other under common computer control.

Controlling the movements trolleys may also comprise the task of keeping track of the actual position of each trolley. The position of each trolley is preferably and advantageously determined based on use of tooth-wheels and encoders on the two shafts controlling the motion. Due to the use of tooth-wheels and encoders on the two shafts controlling the motion and the knowledge of which turn-table has been used for changing direction of a specific trolley, the trolley will, once being indexed, be able to identify its exact position or its exact position will be identifiable in the rail system.

In addition to apparatus to allow control and movement, each trolley has at least one retractable basket (BA) for collection of the pills of at least one multi-dose, and means (AC) for activating the passive gate on a pill stock compartment placed adjacent to the trolley's position. If more pills are required in the same multi-dose the activating means will be instructed by the remote control system to operate the passive gate the required number of times. The trolley may desirably be fitted with as many baskets as are required for the completely packing a distribution box with medicine dose packets, say 28, or more.

Apart from the collection basket and the activation means, the trolleys are in principle equivalent to the locomotives of modern electric model trains with individual electronic speed control except that the rail arrangement is fundamentally three-dimensional. The mechanical arrangement could be as in FIG. 25, where (RA) is the rail seen in cross section, (SHA) is the major bearing allowing the trolley apparatus to maintain its vertical direction by means of gearbox (GE), (DR) is the main driving tooth-wheel with teeth in axial direction, (TI) is an intermediate tooth-wheel and (TDR) is the driving tooth-wheel. Four prism-type bearing wheels (PR) (2 shown), two at one and two at the other side of the rail provide the unit clamped to the rail.

By keeping the major bearing (SHA) steady and turning the main driving tooth-wheel (DR), the trolley will move along the rail. By turning the major bearing (SHA) and the main driving tooth-wheel (DR) in the same direction 90 degrees the trolley will turn 90 degrees with respect to the rail. If this movement is carried out synchronously and in the opposite direction of the turntable, the trolley will keep its vertical position.

A control computer interfacing to all the trolleys by known wireless means, e.g. Bluetooth or wireless LAN contemporary controls the movements of all trolleys using sophisticated, but well known dynamic programming algorithms to achieve shortest travel length and optimal passing strategies subject to the constraints imposed by the position of the side-tracks.

According to the invention, the information that governs the packaging of the pills is automatically routed from the CMD controlling all information related to the pill dispensing system to the packaging machine's control computer.

Following collection of the pills for a particular multi-dose in the basket of a particular trolley, the trolley is directed to move to one of a possible multitude of packing stations (PS) where all multi-doses for a single distribution packet (see FIG. 17) for a particular medicine user are finally packaged, possibly after individual printing and labelling and possibly hermetically, and finally assembled into a distribution packet.

The distribution of packet could be performed in well know ways of distributing possibly ordered collections of items, e.g. collected and placed on a tape or belt collected, an ordered collection in a reusable container, or a bulk in cases where the packages have identical contents or where printing or colour coding provides means for visual discrimination.

In order to provide doses of varying strength of the same drug, the packaging machine according to the present invention have preferably compartments for all possible doses sizes and drug types.

According to a different embodiment of the packaging machine as the one described above, the basic drug agent is a liquid and contained in a container with a valve substituting the passive gate of the packaging machine descried. Instead of a basket, the trolleys are equipped with pieces of edible blotting paper or similar porous material prepared, if necessary to avoid any influence on the medicine, with known inactive drug packaging material (gels, sugar etc.) to be able to accept a controlled, but variable dose of the liquid drug agent. To the extent, that cross contamination is not a problem, which information is controlled by the control computer, several drug types may be applied to the same piece of blotting paper.

In cases where cross contamination is a problem, several pieces of drug collecting blotting paper is used either in the same trolley or in different collection sessions. Similar to the pill collection process, the pieces of drug wetted blotting paper are collected and packaged, either contamination wise separated, but together in the same multidose package or in adjacent multi-dose packages.

These packages are much more compact than the pill packages previously described, but are basically handled the same way as described for pill containing multi-dose packages. The advantage of using drug wetted blotting paper based multi-doses is that the final packages are much smaller, and that the pill dispenser, although maintaining all features previously described can be made much thinner/flatter and less wide.

It is possible to apply the basic principle of packaging liquid drug wetted blotting paper in another preferred embodiment of a packaging machine, where the liquid drugs are connected to valve equipped spray nozzles, much like the printhead of an ink jet color printer, but with as many nozzles as there are drug types.

The collecting blotting paper is now passed by the nozzles (or vise versa) and liquid drug is sprayed onto the blotting paper for drug types and in the amounts required.

In yet another embodiment of a packaging machine for a pill dispenser capable of providing varying dose strength of different medicine types, the medicine is manufactured on large slips of blotting paper in varying amounts and concentration. The various areas of blotting paper containing the different types of medicine are separated from each other by preconditioning with edible oil/fat/wax/lacquer or glucose, and the final prepared slip is coated with similar ingredients to protect the medicine against oxygen, other gases and moisture.

The associated pill dispenser consists of two pullesy. The fresh roll of medicine impregnated blotting paper is mounted on one pulley, and a leader tape is secured to the other pulley.

Between the pulleys is a punching head with several punches, allowing preferably rectangular pieces of plotting paper to be punched out from specified places on the slip and in specfied number to meet the required dose at that particular moment. All other features og the pill dispenser regarding operator interface and data communication is as described above.

Central Medication Database (CMD)

An object in relation to the Central Medication Database according to the present invention is to enable controlling drug prescribed administration and interconnected to pharmacies or other drug distribution centres. Furthermore, the databases preferably maintain routing of alert calls via a number of wired or wireless means. In addition to these features, the Internet connected and dispenser connected database CMD) and its associated application programs, being applied in context with the invention, have a number of preferred features and preferred functions, some of which are set forth in the following:

Due to the online connectivity between the CMD and the pill dispenser the database is concurrently updated of the medicine distribution actually performed in each and every pill dispenser connected to the database and constructed according to this invention.

In case the medicine user did not take the medicine in the right time window, the CMD and its associated software programs may, if so instructed, be able to alert health care persons or relatives, by any know remote means, in particular mobile telephones.

The CMD and its associated software will be able to adjust packaging at the pharmacy or medicine packaging central of the next-to come multi-dose distribution packet for the particular medicine user with respect to medicine in the pill dispenser, that has not been taken at proper time, hence saving the consumption of medicine.

In case medicine should not be reused or the dose is changed, the CMD and its associated software will be able to inform the pill dispenser of whatever new strategy to adapt, including the deposition of obsolete dose packets in the loader at the next placement in the loader for charging or medicine packet loading as well as automatically and preferably via internet inform the pharmacy or unit packaging the medicine about change of medication and the possible immediate requirement of a new distribution packet with changed contents.

The CMD and associated software and the very high degree of automatic reporting of non-compliance in the intake of medicine provides means for statistically evaluating the need for additional medicine user information, information to physicians, campaigns etc.

The CMD and its associated software also provides means for providing valuable information not only on the amount of prescribed medicine, but also on the actual distributed and consumed (at least to the point where medicine is taken form the dispenser) medication and on medication returned for waste or recycling and hence provides valuable means for effective use of medicine and reduction of waste to the environment.

Further the CMD and associated software provide means for providing statistical data on all other goods than prescribed medicine administered through the pill dispenser.

The Central Medicine database, as described as part of this invention is different to electronic patient journals and previously described prescription register at least in that, besides providing automatic and well controlled means for handling the prescription procedure, the maintenance of continued delivery of medication, and routing of alert in case of default to care persons it also, by means of its continuously updated registers on the contents of each and every patients pill dispensers, is capable of managing the proper reuse of medicine doses not taken by the medicine user, as well as managing the proper collection of discarded medicine from the loader's dedicated box for this purpose.

Furthermore the database and associated software will be able to handle a change in medication strategy, by optimising the use of remaining doses from previous strategies and still collecting, for possible reuse, the medicine no longer relevant.

Yet further, the CMD of this invention provides means for on-line regulation of medicine dosage based on diagnostic measurements performed on the medicine user, possibly and preferably in the medicine users own home and transferred to the CMD and possibly the referring physician and via pre-programmed dosage strategies back to the pill dispenser to provide accurate dosage to the extend the pill dispenser and its contents of medicine doses allow.

It is contemplated, that the person skilled in the art is familiar with common mechanical means encompassing spur gears, angled tooth-wheels, lead screws, scissors jacks, cranks, friction wheels, belt drives, friction clutches, claw clutches and lever mechanisms and it is contemplated that the means described herein may be implemented in a variety of ways using commonly means mechanical means

Various Aspects of and Means Comprised in Preferred Embodiments of the Present Invention

In the following various advantageous aspects of and means comprised in preferred embodiments of the present invention are disclosed. It is contemplated, that variations as well as combinations of features described in connection with the preferred embodiments outlined above as well as the those feature described are possible.

Use of the Medicine Dispenser

Patients use medicine dispensers to dispense multi-dose packages with primarily medicine but also with vitamins, over the counter medicine, contact lenses, creme ampoules etc. The patient starts the dispensing procedure by reacting to one of many signals that the medicine dispenser is programmed to signal. The warning can be visual, audio or vibrational and can both be given by the medicine dispenser and via an interface by an alerter that can be a cellular phone. The patient present legitimisation to the medicine dispenser and activates it. The medicine dispenser dispense thereafter automatically a dose package with both the patients prescribed medicine and the other goods ordered by the patient.

Protection Against Wrong Medication

The medicine dispensers CPU is programmed individually to make sure that the patient only is allowed access to one certain dose packages within a pre specified time window. If the dose package is not taken it will remain inside the medicine dispenser. This secures the patient against taking more medicine dose at the same time and thereby exposing them selves to medicine poisoning. Because the patient do not have constant physical access to the medicine the patient avoids the temptation to take more medicine than prescribed. The possibility of illegal sale of medicine and dangerous self medication of members of the family and others are eliminated because patients never get there medicine delivered in accessible packages.

Help to Improved Medicine Compliance

The patient can after agreement with his or hers physician order a complete medicine logbook and in particular that the medicine dispenser report to either physicians, health care professionals, rescue teams or relatives if the patient do not comply with their medicine therapy. For the patient this means extra security and much needed support from health care professionals and relatives that can help by contacting the patient whenever the prescribed therapy is not kept. For physicians and other health care professionals the logbook provide a possibility to act actively before problems get out of hand. For researchers and policy makers in the health care sector the logbook provides a new efficient tool with insight into medicine compliance.

Communication via the Internet

The medicine dispenser communicates through a number of interfaces with other devices. When the medicine dispenser is linked to a device that is able to go on the Internet, then the necessary information is transferred to a database. This database is programmed in a way that data is sorted and made available without the associated personal data. By agreement can data be made accessible for physicians and other health care professionals and as mentioned also to friends and relatives helping the patient to maintain the medicine compliance.

Design for Both Weak and Advanced Users

The medicine dispensers size and weight makes it portable everywhere. And the concept and design has taken the outmost to the many users with both tactile and mental handicaps that makes it difficult for them to use devices. The communication between the medicine dispenser is in consequence very simplified. More advanced communication is however a facility for every user who need this and is capable. This is done by contacting the medicine dispenser via the built in interface. This allows for communication between the medicine dispenser and electronics devices such as PC, cellular phone, PDA and the likes. Patients can stay in direct contact with their physician via e-mail and order medicine and goods to be supplied via there medicine dispenser over the Internet. In this connection the medicine dispenser is a very safe physical link for medicine ordered and delivered through the Internet. The medicine can according to agreement with a physician be prescribed and be packed to be dispensed by the medicine dispenser that thereafter makes sure that the medicine is dispensed according to the prescription.

Safe Rational Medicine Packaging Reduce the Human Risk Factor

Dose packaging is automated by machines that minimise the risk for errors as compared with dose packaging done by health care professionals, relatives or the patients. Dose packaging by machines also imply considerable work efficiency improvement. This has an importance for pharmacist and health care professionals that use a large proportion of there working time to pack and check medicine compliance. The medicine is taken from large medicine packages for hospital use that is far cheaper per pill than smaller packages for patients. This logic packaging saves each patient for a considerable medicine expense.

Different preferred embodiments of packages of medicine according to the present invention is placed in the below table 1:

| | | Type Wrigley |
|---|---|---|
| Type strip | Type packages | (Laminate) |
| Strip for autoload | Packages in stacks | For cut |
| Strip for cassettes | Packages for pater | For cut |
| | noster with sidekick | |
| Strip with lid- and | Packages in pater noster | |
| container foil | work with front battery | |
| | and electronics cabinet | |
| Strip with lid- and | Packages in pater noster | |
| container foil | work with front | |
| and carrier foil | electronics cabinet and | |
| | side battery cabinet | |
| | Packages in pater noster | |
| | work with side battery | |
| | and electronics cabinet | |
| | Packages in pater noster | |
| | work with side battery | |
| | and electronics cabinet | |
| | and top/bottom cabinet | |
| | for prismatic battery | |

Type Strip is Divided into Two Variations:

The first variation is based on autoloading, where a strip with dose packages loads into the medicine dispenser.

The other variation is based on a cassette, where the strip is loaded into the cassette by the supplier and then connected to a plug in with motor, battery, sensors and electronic for control and communication.

Medicine Dispensers of the Type Packages is Divided into Six Variations

Packages in stacks variations is found with one, two, three or four stacks, that are pushed forward by a spring. In variations with one stack the dose packages comes out successively with identical dose packages containing the same medicine. In variations with two stacks the dose packages comes as for instance a morning and night dose packages. In variations with three stacks the dose packages comes containing for instance morning, midday and night dose packages. In variations with four stacks the dose packages comes containing for instance morning, midday, evening and night dose packages. The advantage of this design is a simple construction.

Packages with pater noster and sidekick consist of three sections, where there in two sections is rotation stacks of dose packages and in the third a side kick room and room for battery and electronics. The advantage with all pater noster designs is the possibility for reuse of dose packages, that can be kept inside the medicine dispenser until their later on can be a part of the prescription. The design with three sections in the same module has the advantage of achieving a shorter length of the medicine dispenser.

Packages with pater noster and front battery and electronics cabinet consist of two sections of dose packages that is rotated in a pater noster and a front cabinet containing battery and electronics. The advantage by placing the electronics and the battery in front is short circuit connections and short distance between electronics and sensors. Packages with pater noster and side battery and electronics cabinet consist of two sections of dose packages that is rotated in a pater noster and a side cabinet containing battery and electronics. The advantage by placing the electronics and the battery on the side is better dimensions on the medicine dispenser.

1. Packages with pater noster and side electronics cabinet and top/bottom battery cabinet consist of two sections of dose packages that is rotated in a pater noster and a side cabinet containing electronics and a top/bottom cabinet containing battery. The advantage by placing the electronics and the battery on the side is better dimensions on the medicine dispenser.

Description of Medicine Dispensers of the Type Strip

The package and insertion strip is the principal physical interface between the medical therapies content, package machinery, medicine dispenser and patient.

It is an element always connected to the service. And an element that never must fail and therefore must comply to strict demands.

Two Embodiments of Strips to Medicine Dispensers Type Strip

The package and insertion strip is delivered in rolls of pre fabricated foils with added print, cut, impress, paint, stickers, transducers and chips.

There is two embodiments:

1. With lid foil and cup foil.

2. With lid foil and cup foil and carrier foil

Strip with Lid Foil and Cup Foil

In such embodiments, the strip is made in a way so that one foil functions as a lid and the other as a cup.

The lid foil and the cup foil is both fitted with tracking holes as for stand camera films and with a cross impress. The tracking holes can both be in the sides and between the dose packages on the strip. The purpose with the tracking holes is to secure traction during autoloading and winding inside the medicine dispenser and to secure motor activated parts such as pins, knifes, rejecters etc. access to interact with the mechanisms placed internally on the casing of the medicine dispenser. The purpose of the cross impress is to create a mobile joint, making the entire strip easier to wind around the spools without friction and to secure a better positioning of the strip.

The lid foil and the cup foil is both with small bridges to the dose packages, that with small tension leading cuts are easy to cut precisely when the dose packages must be cut lose and dispensed to the user.

The lid foil and the cup foil is supplied in different states of pre fabrication to be joint inside the packaging machine. The strip is made with tactile identifications either cut or impressed. The strip is made with visual identification either printed and lacquered on. In order to help users to handle the dose packages they are made with photo active colours or a photo active material.

Strip with Lid Foil and Cup Foil and Carrier Foil

In this embodiment the strip is made with three foils with the supplement of a carrier foil. The carrier foil carries the dose packages that are made from the lid foil and the cup foil. The carrier foil carries the dose packages by gluing, attachment or physical entanglement, where the carrier foil is entangled with the cup foil. Here by is it achieved that a simple rejecter without knifes can loosen the dose packages.

The advantages with carrier foils is a considerably larger mechanical stability because it will not be destabilised as a ladder without steps when the dose packages are released.

Two Embodiments of Medicine Dispensers for Strip

medicine dispensers based on strip has two embodiments:

1. medicine dispenser for autoload.

2. medicine dispenser for cassette change.

Medicine Dispenser for Autoload

In this embodiment the medicine dispenser is made with a hard casing with room for strip and CPU plug in. The medicine dispenser casing is assembled by mainly three parts:

1. Right side shell

2. Left side shell

3. Central assembly part

Right and left side shell is mirrored and integrate in their shape guide for the strip, guide for the CPU, channels for rubber bands and guide for closing lid and guide for bayonet attachment for mailing package. Both right and left shell cab integrate holes for contacts, light diodes, display, recharge, speaker, screws etc.

The central assembly part collects right and left shell and is integrated with a knee joint with an attached rolling contact, springs for guide of the strip, channels for rubber bands and bar for constructional strengthening of the cabinet and a closing lid. The knee joint opens the closing lid when a flexible pawl is pushed from the CPU plug in into a impression on the rolling contact, which is moved until the pawl no longer can stay in the impression.

Here by the knee joint leaves its stretched position and retract to its inherent moulded form. The knee joint is stretched to close the closing lid when a pawl is pushed out from the CPU plug in to the rolling contact in a way so this locks the knee joint in a fix. The closing lid moves in guides.

The knee joint is particular by the fact that it can be mechanically operates through the strips holes and by the fact that it can be machined as an integrated plastic part with rolling contact, knee joint, closing lid, springs, bars and assembly function.

The springs to guide the strip is made in a way that a soft curve ensures gentle passing inside the cabinet for the strip. Channels for rubber bands is placed as defined friction points in order to ensure that the medicine dispenser in spite of its lightness and smooth plastic cabinet has sufficient friction. Bars for constructional strength is placed between the dose packages to give the medicine dispenser a larger strength.

Two Embodiments of the CPU Plug in

CPU Plug in for Strip Medicine Dispensers with Autoload

CPU plug in is made for an autoload medicine dispenser as a flat box that is placed in the middle of the medicine dispenser surrounded by the strip. In each end of the box there are a spool to wind the strip. In the end near the closing lid there is a motor to drive the spool. The motor can either drive on the shaft or via a gear exchange. Spooling can only go clockwise. The motor is controlled by the CPU plug in based on sensor input with registration of the strip position.

When a dose package is ready for dispensing the CPU stops the motor in correct position based on feedback from the sensor. Then the motor start to go anti clockwise. This carries a series of mechanical actions. First the closing lid opens by bending the stretched knee joint. Then the dispensing action is activated (in the variation with lid foil and cup foil this is done with knifes and rejecters. In the variation with lid foil, cup foil and carrier foil this is done with rejecters only) And finally the closing lid is closed again.

CPU Plug in for Strip Medicine Dispensers with Cassette

CPU plug in is made to autoload medicine dispensers with to interconnected and attached casings. One on the side of the medicine dispenser, where it finish the form given by the cassettes dimensions. One that fits internally in the middle of the medicine dispenser inside the cassette surrounded by the strip. Motor, gearing and activation of the closing lid functions as described above. The motor can both be placed on the side and in the middle of the medicine dispenser.

Two Embodiments of the Mailing Box

Mailing can be done in two principally different ways:

1. In a special mailing box for the strip that later on via autoload is transferred to the medicine dispenser.

2. In a cassette where the strip is transferred to a cassette at the pharmacist, that later on will be connected with a CPU plug in containing battery, motor and electronics.

Autoload Mailing Box

The mailing box consist of a package made out of card board, plastic or the like. The package is sealed with a sticker, that can include postal address and coding.

Identification of the autoload mailing box can be done with bar codes, punched card, magnet tape, chip and transducer.

Cassette Mailing Box

The cassette is strong enough to be mailed as a letter. This is just demanding an envelope or possibly just a sticker with address.

Identification of the cassette mailing box can be done with bar codes, punched card, magnet tape, chip and transducer.

Information on Medicine (Applies for All Medicine Dispensers)

Information on medicine is regulated by law. The information can be supplied in print, on chip, on magnet tape and as a code (codes, punched card, magnet tape, chip and transducer) that authorise access to collect the information via the internet. The information can be in the form of pictures, text, blind text and speech. The information can be transmitted directly from the medicine dispenser from other devices via communication interface. The CPU plug in can contain a loud speaker and a microphone so it becomes possible to use voice command and voice recognition—voice activation.

Auto Loading

The package and insertion strip must be possible to identify automatically by the medicine dispenser as the correct new dose package. This is based on a sensor that reads the code or coding that has been chosen for the mailing box and strip.

Autoloading Procedure

The medicine dispenser is emptied for used.

The medicine dispenser and the Mailing box are connected with a bayonet attachment.

By the attachment the strip is brought in position so the built in spool can attach to the strips traction holes, Hereafter the strip is spooled until it is placed inside the medicine dispenser cabinet ready for use.

Cassette Mount Procedure

The CPU plug in is taken out of the used cassette and inserted into a cassette with new dose packages. The new cassette is identified by a key card (Physical design like car keys where there are a limited number of cassettes and medicine dispensers that fits together), codes, punched card, magnet tape, chip and transducer. The identification is done by the medicine dispensers built in sensor. (We prefer transducer that are cheaper and readable in 360 degrees without demands of a precise positioning or a moveable sensor.)

Dose Packages in Strip

Whether its an autoload or a cassette medicine dispenser the strip must comply with a number of demands. Some of these demands are part of the legislation. The pills must be kept protected against oxygen, water and other agents and gasses that can contaminate or decompose the pills. This is done by an airtight package with a protective atmosphere inside. The pills must be kept fixed, so they are not worn by constant friction and vibrations. This is achieved by packaging the pills in under pressure similar to that inside flight cabins and the highest parts on earth. This procedure ensures that the dose packages at no time explode or expand so much that they block the medicine dispenser. This is specially relevant in connection with the present invention.

Identification of the dose packages can be done fully automated by scanning of punched card, magnet tape, chip and transducer+transducer tablet, that consist of a tablet containing a transducer.

Tactile identification of the dose packages can be done by cutting the dose packages or attaching specially formed stickers, furthermore impression can be added to the lid foil and the cup foil.

Visual identification of dose packages can be done with three dimensional differentiation as mentioned above plus print, stickers, coloured foils, foils with photo chemical colour shift. This is specially relevant in connection with the present invention because it gives the special advantage being able to light the dose packages inside the cabinet and afterwards dispensing them while they are still emitting light making them easier to see in for instance a dark bedroom.

Opening of Dose Packages After Dispensing

We are dealing with people and often people that are not entirely tactile apt or otherwise handicapped, so the opening of the dose packages must be very simple.

The following methods is specially useful in connection with the present invention: Automatic opening shortly after the dose package leaves the medicine dispenser by electric desolution of the glue. Each dose package is closed with a electrically leading glue/wax that is melted and loosened by sending an electric current through it. Specially useful for both type strip and type packages.

1. Automatic opening shortly after the dose packages leaves the medicine dispenser by UV desolution of the glue. Each dose packages is closed with an UV sensitive glue that is degraded and loosened by UV radiation. Specially useful for both type strip and type packages.

2. Manual opening by cutting of the dose package by use of the same type of knifes used to open coffee packages on coffee machines.

3. Manual opening by cutting of the dose package by use of the same type of knifes used to cut a single sheet of paper. This type of knifes are very small and therefore possible to place on the side of the medicine dispenser cabinet. This is done by fitting the medicine dispenser with a ruler fitting to the dose package. The dose package is drawn over the knife.

Design Expression

It is preferred that the package and insertion strip can:

1. Present the medicine inviting and well arranged as an intelligent package.

2. Make patients feel secure and in competent hands without though making them feel without control.

3. Give the patients the impression that they are served and not stigmatised by a aid device and therefore the design must be closer to commercial packages like cosmetics rather than classic serious technocratic medicinal style.

4. Appear self-confident and differentiated with for instance a flower like biologic impression.

Electronic Interface

The following electronic interfaces are useful in connection with the present invention:

1. Interface other electronic devices (fixed wire phones, mobile phones, alerters, PC, home diagnostic equipment etc.) via built in phonecard, Bluetooth, FM, infrared light, sound modem and wired connection.

2. Interface to the internet and database via other electronics and built in phonecard.

3. Upload of programmes via internet based ASP solution or simple data exchange via built in phonecard, Bluetooth, FM, infra red light, sound modem and wired connection.

4. The interface is coded, so mainly persons with authorisation can alter the setting of the medicine dispenser functionality. All actions are registered in a database.

5. The interface must mainly grant access to persons with cleared access in acute situations.

6. The interface must mainly function as a electronic medicine passport that automatically offers customs and other officials information on the legal content of the medicine dispenser.

Control

The following control possibilities is useful in connection with the present invention: The Identification of patients with tags with (Chip, transducer, magnet tape, bar codes, thump scanning, blood wain scanning, hand scanning, pupil scanning, voice recognition.) in order to prevent patients from accidental operating wrong medicine dispensers.

Identification of acceptable strips and packages (Chip, transducer, magnet tape, bar code, punch card or key card), so an other persons package and insertion strip cant be loaded by mistake.

1. The identification of each medicine portion by an inactive transducer, which can be followed through the stomach. With the respect to analyse whether patients actually takes the medicine or just empty their medicine dispenser and through the medicine away. This specially useful for patients that do not want to engage them self in their medicine compliance. But also as extra security for medicine compliance in general.

2. Code for alarming patients via light, sound and/or vibration.

3. Auto-alarming by sensor detection of programmed abnormalities of any sort with relevance for the patients medicine compliance. Alarming must be distributed to the proper person be it a physician, a pharmacist, a nurse, a relative or others.

4. Auto-alarming by programmed signals on low battery charge.

5. Auto-alarming by the time for loading of new dose packages or shift of cassette with dose packages.

6. Auto-alarming by serious irregular medicine compliance.

Design Aesthetics

medicine dispenser must mainly be able to:

1. Express intelligent control rather than stigmatised dependency.

2. Express quality with camera like finish and quality materials.

3. Present medicine in dose packages with design quality like cosmetic packages.

4. Be configured personally with colours and tactile elements.

5. Age with scratches, dirt and bleaching aesthetic degradation.

6. Function without noisy motors, rattling pills and electronic bips.

7. Used with no risk of marking furniture and the like.

Description of Medicine Dispensers of Type Packages

Medicine Dispensers of Type Packages can be Divided into Four Variations:

1. Packages in stacks variations is found with one, two, three or four stacks, that are pushed forward by a spring. In variations with one stack the dose packages comes out successively with identical dose packages containing the same medicine. In variations with two stacks the dose packages comes as for instance a morning and night dose packages. In variations with three stacks the dose packages comes containing for instance morning, midday and night dose packages. In variations with four stacks the dose packages comes containing for instance morning, midday, evening and night dose packages. The advantage of this design is a simple construction.

2. Packages with pater noster and sidekick consist of three sections, where there in two sections is rotation stacks of dose packages and in the third a side kick room and room for battery and electronics. The advantage with all pater noster designs is the possibility for reuse of dose packages, that can be kept inside the medicine dispenser until their later on can be a part of the prescription. The design with three sections in the same module has the advantage of achieving a shorter length of the medicine dispenser. The stacks are rotated by two pater noster works, (one that can be adjusted to fit the length of the stack and an other that remains positioned close by the sensor and the in/out opening for dose packages.) by means of motor power that pushes the individual dose packages forward, sideward or in/out in a coordinated succession. To the enable the sideward movement the pressure from the stacks is blocked by activating a shield between the active volume in the two pater noster works where the sideward and in/out movements is done. The shielding is deactivated mechanically when the next dose package in the stack is ready to enter its position in a pater noster work. The shielding is activated mechanically when the pater noster work in the sensor end must handle in/out or sidekick retrieve/deposit movement of dose packages. Loading of the medicine dispenser is done by mounting a mailing box in a bayonet attachment or hinged attachment and then pressing upon the mailing box so it like “PEC” tablets transfer one dose package one by one to the medicine dispenser. Each new dose package in the mailing box is pressed forward by a spring in the bottom and into the medicine dispenser with a piston. The advantage with all pater noster designs is the possibility to reuse dose packages that can be kept inside the medicine dispenser until they later on can be used in the patients medicine compliance. This design with three modules has the advantage of being relatively shorter.

3. Packages with pater noster and front battery and electronics cabinet consist of two sections of dose packages that is rotated in a pater noster and a front cabinet containing battery and electronics. Contrary to packages with pater noster with sidekick variation, there are no handling of sidekick retrieve deposit movement of dose packages. The advantage by placing the electronics and the battery in front is short circuit connections and short distance between electronics and sensors. Furthermore is it simpler to move the dose packages around in only two rotating stacks.

4. Packages with pater noster and side battery and electronics cabinet consist of two sections of dose packages that is rotated in a pater noster and a side cabinet containing battery and electronics. The advantage by placing the electronics and the battery on the side is better dimensions of the medicine dispenser.

5. Packages with pater noster and side electronics cabinet and top/bottom battery cabinet consist of two sections of dose packages that is rotated in a pater noster and a side cabinet containing electronics and a top/bottom cabinet containing battery. The advantage by placing the electronics and the battery on the side is better dimensions of the medicine dispenser.

Dose Packages Type Package

Dose packages type package consist of an injection moulded or extruded frame. Around the frame there is a foil package (Like a normal foil package around for instance candy). The packaging procedure is that pills etc. is placed in the frame and thereby in the foil package. The foil package is closed and the ends are put over the frame and glued to the top side. Then the dose package is removed from the under pressure in the packaging machine where after they implode around the frame and the content of pills etc. The dose packages size and dimensions are now precisely defined as the frame plus a thin foil layer. The constant defined outer dimensions makes it possible to handle the dose packages as standard containers in the medicine dispensers pater noster work and the rotating stacks.

In order to be able to scan a transducer pill inside the dose package the backside of the foil around the frame is covered with aluminium to shield the sensor of transducers in other dose packages in the rotating stacks.

In order to handle the dose packages the frame can be made with grooves, holes etc. Grooves can be placed on all sides and edges and so can holes. Grooves and holes makes it possible to use cog wheels and pawls to interaction and transportation of the dose packages.

The foil around the frames can be made with a chip, a transducer, a magnet tape and/or a bar code.

Description of Medicine Dispensers Type Wrigley (Laminate)

Common for all medicine dispensers type Wrigley is lamination of medicine between eatable foils. The medicine can contain none or only very few fillers. More laminates with similar or different medicines is pressed together with a carrying foil to form a dose laminate. The laminates can also function as carrying foil by cutting traction holes (Camera film traction holes) and chain impression (crossing impressions that ensures that the laminate is bendable in its joints) for safe control of spool transportation inside the medicine dispenser.

The basic design of medicine dispenser type Wrigley is largely similar to that of medicine dispenser type strip.

Medicine dispensers type Wrigley is of two types:

1. Cut of, where the dose laminate is carefully adapted to the rhythm the patient takes his or hers medicine, for instance morning, midday, evening and night. The adaptation is done by measuring out medicine according to the physicians prescription. This happens by cutting of laminate medicine from prefabricated tapes with medicine. Cuts in different length gives different amounts of medicine. In an other preferred embodiment the medicine is printed any form and pattern of the laminate in a pre fabrication process. In a third preferred embodiment the medicine is printed in the packaging process in the preferred patterns. Inkjet print of medicine on blotting is done by printing a figure in oil/fat/wax/lacquer to contain the medicine so does not just spread as an ink blot on blotting paper, but on the contrary is contained within a pre defined area. The printed oil/fat/wax/lacquer figure can be designed in several ways that gives different surface areas for decomposition in the stomach and intestine canal and thereby different timing of the body's medicine reception and different timing of where the medicine is released and receipted in the stomach intestine canal. (This third embodiment can with particular advantage be combined with laminate layers or oil/fat/wax/lacquer print with the particular character that the decomposition in the stomach and intestines can be adjusted by scaling their thickness. This implies that the medicine is releases from a carefully defined and homogenous or pre programmed area. So it becomes possible to programme the medicines release to the body both concerning timing and pre determined positions in the stomach intestine canal. Ordinary medicine detonate like bombs when they arrive in the stomach because the decomposition happens in a uncontrolled accelerated process due to the fact that pills are decomposition process attacks from 360 degrees leading to a sudden complete decomposition, typically decomposed by the stomach acid.) Hereby it becomes possible to adjust very precisely to the physicians prescription based on diagnose, weight, gender, age, cycles etc. the individual medicine laminates is laminated together to form a joint laminate. The joint laminate is laminated to a carrying foil with traction holes similar to camera films and chains formed by cross impressions in order to ensure safe positioning when the laminate is transported inside the cabinet. Laminates with medicine can be made in a way so the whole laminate contains equal amounts of medicine pr square centimetre or in a way so the medicine amount pr. square centimetre is proportionally adjusted to either morning, midday, evening or night doses. Laminates can have a width proportionally to division into one, two, three four or more daily doses. Laminates with one medicine line can be placed selectively to a planned dose dispensation. By cutting pre programmed prepared doses are dispensed at fixed times.

2. Punching. The dose laminate is either constructed exactly like the variation with cut or the dose laminate is constructed with printed medicine doses, but instead of cut the medicine is punched of the laminate. This increases the flexibility when the dose amount are measured out for dispensing. And likewise also with relation to the distribution of dose intervals over a day. This flexibility is used to increase the dose dynamically. This dynamically adaptation is controlled by the physicians prescription that rather than detailing a static number of doses chooses to detail the doses in a programme that respond dynamically to online measurements of the patients health conditions by optimising the doses. Measurements are sampled from all sorts of home diagnostic devices that are capable of communicating with diverse communication interfaces such as infra red transmission, built in phonecard, Bluetooth, FM, sound modem and fixed wiring. Likewise can the patients access pro necessitate medicine on demand in a way where for instance psycho pharmacies, pain killers etc. can be integral parts of the dose laminate and administered pre programmed by the medicine dispenser on demand for the patient. The pre programming ensures the patient against misuse. This is done in a procedure where the patient puts froward a wish of medication with a specific medicine on the dose laminate. The medicine dispenser s CPU is programmed with the physicians prescription including guidelines for the medicine use and is able to check the logbook to see if it is safe to administer the desired medicine to the patient. This dynamic medicine administration facility with feedback from home diagnostic devices can be combined with learning systems in a way so the medicine dispenser all the time checks whether the desired therapeutic effect is achieved by smaller or larger doses of the active medicine and/or by the different relative combinations. The combination between dynamic medicine administration and learning systems can contribute to faster test and development of new therapies and medicines.

Dose Packages Type Wrigley (Laminate)

Dose packages for type Wrigley medicine dispensers is packed mainly as a separate part. Before loading the dose packages is taken out of a standard (Candy like package.) Wrigley medicine dispensers needs only one integral dose package. It can however be advantageous to integrate more dose packages in the same medicine dispenser because this gives a flexible possibility to avoid having to change the dose package, because a single medicine is used up. The dose package does not need to be changed before it is completely empty.

Packaging Machine

Packaging machines can with great advantage be located with pharmacist. Their size depend partly of their capacity and their content of different assortments. The packaging machines is comprised of one or more of the following elements:

1. Pharmacy desk, where there is bulk packages of pills and other goods with a format that comply with medicine dispensers.

2. Single pill dispensing units

3. Rail for package collectors

4. Package collectors that are small robots that drive around to collect items for packaging medicine dispensers.

5. Railway for package collectors

6. Spools for special foils for manufacture of dose packages

7. Vacuum form machine for manufacture of dose packages

8. Pressure chamber for manufacture of dose packages

9. Foil package line that effectuates the production of dose packages

10. Server that controls the components of the packaging machine

11. Co2 installation

12. Package collectors cleaning facility

13. Air clean facility

Pharmacy Desk

The pharmacy desk is built as a classic pharmacy desk with small and larger assortment chambers for medicine and goods. The large assortment chambers contain big hospital size medicine packages and the smaller assortment chambers contain smaller packages. The front of the assortment chambers are equipped with identification such as colour code, text, print, magnet tape, bar code, chip and transducer. The assortment chambers are identified by scanning, and the identification on the medicine packages the assortment chambers should contain. Hereby we gain a control check of whether it is the right medicine in the right assortment chamber and that the position of the medicine is registered in the server for the purpose of the package collectors navigation.

Single Pill Dispensing Units

Each assortment chamber is connected to a single pill dispensing unit that ensures that one and only one pill is taken at a time from each assortment chamber, single pill dispensing unit are activated by the collector packages by a pawl, a cog wheel or an other sort of mechanical energy tranferral. The purpose is that the single pill dispensing units shall be passive mechanics without motor and thereby need for stored energy. One assortment chamber can have more closely placed single pill dispensing units side by side so they for instance can transfer pills and goods for a whole dose package.

Package Collectors

Package collectors are small robot, that move around behind the pharmacy desk and collect pills and goods from single pill dispensing units. They run on battery and communicates with the packaging machines server via Bluetooth. Activation of single pill dispensing units is done with a mechanical interface that could be a cog wheel, a pawl or something else. Package collectors navigate on rail forming an entire railway.

Railway for the Packaging Collectors

The railway for the package collector is the necessary prerequisite for the movement of package collectors and their precise positioning relative to the single pill dispensing units where they collect medicine and goods.

Assortment Chamber System

The assortment chamber system can:

1. Be handled by staff without prior technical education.

2. Be scaled freely concerning the size and numbers of assortment chambers.

3. Be activated mechanical so every assortment chamber can dispense pills one by one

4. The assortment chambers can be filled from the front without operation stop

5. Be placed in rooms with varying width and heights.

Packages Collectors

Package collectors can:

1. Interface with other electronics (fixed wire phones, cellular phones, PC, etc.) via Bluetooth.

2. The interface must be possible to code in a way so only authorised personnel can interfere with the settings of the package collectors functions.

3. Be recharged and run on batteries so they are independent of wiring both concerning communication and power.

4. Be taken out if errors occur without stopping the rest of the package machine.

5. Be inserted and work without stopping the rest of the package machine.

6. Sense where they are when navigating the rail system behind the assortment chambers.

Packaging Unit

The following functions are mainly carried out by the packaging unit:

1. Manufacture of dose packages from pre fabricated items.

2. Print.

3. Glue.

4. Cut.

5. Impress.

6. Vacuum form.

7. Insert dose packages into mailing boxes.

8. Store mailing boxes for delivery and shipment.

Server

The servers mainly:

1. Receive prescriptions from physicians.

2. Communicate with package collectors, so they are able to navigate and collect the correct medicine.

3. Generate a logbook of handled package prescriptions.

4. communicate with the operator when it is time to refill assortment chambers.

5. Select those prescriptions that it is possible to effectuate with the present registered medicine content inside the assortment chambers.

6. Auto-reordering of medicine supply whenever the packaging machine has used up the local stock.

7. Auto-call to packaging collectors for recharge when their battery charge is low.

8. Run on battery back-up so the package collectors and the package function is unharmed during temporary electricity break down.

9. Auto-alarm of local operator and extern technicians if serious irregularities happens.

It is preferred that the packaging collector can be placed discrete against a wall in a room where there can be other back-office functions. At the same time it is preferred that the package machine can withstand daily use.

Environmental Specifications

It is preferred that packaging machine is able to:

9. Clean it self so medicine dust is constantly removed and collected in a filter, that prevents cross contamination and pollution of the external environment.

10. Package the medicine in a protective oxygen free atmosphere.

11. Be manufactured without using environmentally dangerous materials u.

12. Used without exposing people of dangerous medicine dust/moist.

13. Used without exposing operators to dangerous X/Y movements.

Economic Demands

It is preferred that the packaging machine must be able to:

1. Be sold at variable prices depending on the capacity of the assortment chambers, the package collectors and the packaging units.

2. Be based on automated packaging.

1. A dispensing unit dispensing doses of one or more medicaments housed in the dispensing unit, the dispensing unit comprising
electrical activated mechanical manoeuvre means being adapted to
manoeuvring a dose housed in the dispensing unit from a location where the dose can not be presented to a user and to a location where the dose can be presented to a user, and
manoeuvring the dose to a location within the dispensing unit where it can not be presented to a user subsequent to having manoeuvred said dose to the location where it can be presented to a user
an electronic control unit controlling said electrical activated mechanical manoeuvre means to manoeuvring said dose so that the dose is only present in the location where it can be presented to the user in a specific time window,
memory means for storing information on medication of doses housed in the dispensing unit,
a clock and
means for receiving and storing information about a particular dose's preferred time of dispensing.

2. A dispensing unit according to claim 2, wherein the means for receiving and storing information is adapted to receive and store while one or more doses are being introduced into the dispensing unit.

3. A dispensing unit according to claim 1 or 2, wherein, the time window in which the dose can be presented is contained in the information received and stored.

4. A dispensing unit according to any of the preceding claims wherein the manoeuvring is ruled out by a time schedule contained in the or identified by information received and stored.

5. A dispensing unit according to any of the preceding claims, further comprising an identification tag uniquely identifying the dispensing unit and/or the user of the dispensing unit.

6. A dispensing unit according to any of the preceding claims, wherein the means for receiving and storing information is adapted to sense the information from dose or distribution box to be introduced into the dispensing unit; said information be preferably applied on the dose or the distribution box in the form of bar codes, magnetic coding or the like preferably in readable and writeable form.

7. A dispensing unit according to any of the claims 1-6, wherein the means for receiving and storing information is adapted to receive the information via a wireless network, the receiving being preferably based on a unique identification of the dispensing unit and/or the user of the dispensing unit and preferably based on a preferably unique identification of the doses being introduced into the dispensing unit, said identification of the doses being preferably contained in information applied on the dose or the doze magazine.

8. A dispensing unit according to any of the preceding claims, further comprising one or more cutting devices adapted to cut open a dose presented by the dispensing unit, said cutting devices being preferably shielded and/or shaped so as to avoid cutting skin and cloth.

9. A dispensing unit according to any of the preceding claims, further adapted to detecting dispensing of a dose.

10. A dispensing unit according to claim 9, further adapted to store the time a dose is presented.

11. A dispensing unit according to any of the claims 4-10, wherein the means for receiving and storing information is adapted to transmit in a wireless manner an emergency call to one or more predefined persons and/or authorities in case one or more dose is not presented according to the stored time schedule or in case a missing but prescribed reaction from the user is detected.

12. A dispensing unit according to any of the preceding claims, further comprising an interface for interfacing a medical appliance, such as an appliance for measuring blood sugar, pulse or the like, and for transferring data originating from such appliance to the memory means of the dispensing unit, and wherein the means for receiving and storing information is adapted to transmit such data in a wireless manner to medical authorities or nursing staff.

13. A dispensing unit according to any of the preceding claims, wherein the controlling unit is adapted to store the time when a particular dose is presented from the dispensing unit.

14. A dispensing unit according to any of the preceding claims, further comprising interface means for electrical connecting to the dispensing unit external equipment for reading the content of the dispensing unit's memory, such as for reading the stored times of when particular doses are presented.

15. A dispensing unit according to any of the preceding claims, wherein a number of predefined time schedules are stored in the dispersing unit before any information is received and stored by the means for receiving and storing, each predefined time schedule prescribes a number of daily or weekly time windows for a limited number of dose types, e.g. 10, and wherein the location of each dose in the dispensing unit and each dose's time window are applied as a machine readable code.

16. A dispensing unit according to any of the preceding claims, further comprising activating means activating the dispensing unit, said activating means comprising an electronic reading unit for reading a tag or the like carried by and uniquely identifying the user of the unit by a battery less circuit to be read by the electronic reading unit (RFID), and said activating means is adapted to only activate the dispensing unit when a positive identification of the tag has taken place.

17. A dispensing unit according to any of the preceding claims, wherein the manoeuvrings means comprising a closed loop conveyer with a conveyer belt having sections being flexible connected at their ends to form a close loop conveyer and wherein the conveyer belt comprise means for holding a dose.

18. A dispensing unit according to any of the claims 1-16, wherein the manoeuvrings means comprising a closed loop conveyer with a conveyer belt having first sections flexible connected at their ends to second sections to form a closed loop conveyer belt, the stiffness of the first sections being higher than the stiffness of the second sections and the longitudinal direction, measured in the conveying direction, of the first sections being shorter than the longitudinal direction of the section sections so that the sections of the conveyer belt may travel in two parallel planes distanced from each other substantially by the longitudinal length of the first sections.

19. A dispensing unit according to claim 18, wherein the conveyer belt, such as either the first sections or the second sections or both sections, comprise means for holding a dose.

20. A dispensing unit according to claim 19, wherein the conveyer belt, such as either the first sections or the second sections or both sections, comprises upright members defining there between compartments for doses.

21. A dispensing unit according to any of the claims 17-20, wherein the means for holding a dose is constituted by one or more elongated members, preferably being cylindrical shaped, cone shaped or the like, adapted to co-operate with one or more cavities provided in a pack to be conveyed by the conveyer belt for carrying the pack while being conveyed.

22. A dispensing unit according to any of the preceding claims, further comprising a election mechanism for ejecting a dose from the dispensing unit, when said dose is in the position where it can be presented to a user.

23. A dispensing unit according to any of the preceding claims, wherein the unit further comprising a closing means for closing a dispensing opening in which a dose is presented to a user.

24. A pack for a medicament in form one or more pill or the like, which medicament is to be dispensed at one time, said pack being substantially emptied from gas and is provided by
a supporting structure having one or two openings each being closed in a sealed manner by a deformable sheet-like material,
wherein the material of the supporting structure and the sheet-like material are chosen so that when the gas is emptied out of the pack then no substantial deformation of the supporting structure occur and a substantial deformation of the sheet-like material occur resulting in that the medicament in the pack is fixed within the pack.

25. A pack according to claim 24, wherein the supporting structure comprises one or more cavities each adapted to co-operate with an elongated member, preferably being cylindrical shaped, cone shaped or the like, for carrying the pack while the pack is being conveyed.

26. A pack according to claim 24 or 25, wherein sheet-like material is tubular shaped wherein the supporting structure is arranged, the sheet-like material having one or more initial open ends extending beyond the extension of the supporting structure, said open end(s) being sealed to form a sealed pack.

27. A pack according claim 46, wherein the open end(s) being sealed by folding and fixing, preferably by gluing, welding or the like, the fold to the supporting structure so that the contour of the pack is substantial equal to the contour of the supporting structure.

28. A pack according to any of the claims 24-27, wherein the gas is emptied out of the pack.

29. A pack according to any of the claims 24-28, wherein the gas present in the pack or remaining in the pack after gas has been emptied out is substantial constituted by an inert gas.

30. A pack according to any of the claims 24-29, wherein the pack is prism shaped.

31. A pack according to any of the claims 24-30, wherein the supporting structure is frame shaped.

32. A pack according to any of the claims 24-30, wherein the supporting structure is constituted by a lid-less container.

33. A dispensing unit according to any of the claims 1-24, wherein each dose is contained in a pack according to any of claims 25-32.

34. A central medication database system adapted enable controlling medicine dispensed by a medicine dispenser according to any of the claims 1-24, said system being able to be interconnected to pharmacies or other drug distribution centres and being adapted to maintain routing of alert calls either via a wired or wireless communication or a combination thereof and being connected, at least temporarily to said dispenser.

35. A central medication database system according to claim 34, wherein the dispenser is able to be connected to the data base system via the Internet connected.

36. A central medication database system according to claim 34 or 35, being adapted to update the database concurrently of the medicine dispensing actually performed in each and every pill dispenser connected to the database.

37. A central medication database system according to any of the claims 34-36, being adapted to in case the medicine user did not take the medicine in a prescribed time window alert health care persons or relatives, preferably by mobile telephone.
